(19) United States
(12) Patent Application Publication
(10) Pub. No.: US 2017/0214752 A1
(43) Pub. Date: Jul. 27, 2017

(54) SYSTEMS AND METHODS FOR PROVIDING GEOGRAPHICALLY DELINEATED CONTENT AUTHOR INFORMATION

(71) Applicant: Co Everywhere, Inc., New York, NY (US)

(72) Inventors: Anthony Longo, Boston, MA (US); Daniel Alan Adams, Melrose, MA (US)

(73) Assignee: Co Everywhere, Inc., New York, NY (US)

(21) Appl. No.: 15/257,616

(22) Filed: Sep. 6, 2016

Related U.S. Application Data
(63) Continuation-in-part of application No. 14/610,071, filed on Jan. 30, 2015.
Application No. 14/610,071 is a continuation-in-part of application No. 14/572,270, filed on Dec. 16, 2014.
Application No. 14/572,270 is a continuation-in-part of application No. 14/610,312, filed on Jan. 30, 2015.
Application No. 14/610,312 is a continuation-in-part of application No. 14/572,270, filed on Dec. 16, 2014.
Application No. 14/572,270 is a continuation-in-part of application No. 14/572,270, filed on Dec. 16, 2014.
(60) Provisional application No. 62/214,369, filed on Sep. 4, 2015.
(60) Provisional application No. 61/995,015, filed on Apr. 1, 2014.
(60) Provisional application No. 61/963,849, filed on Dec. 16, 2013.
(60) Provisional application No. 61/963,850, filed on Dec. 16, 2013.
(60) Provisional application No. 61/995,015, filed on Apr. 1, 2014.
(60) Provisional application No. 61/963,849, filed on Dec. 16, 2013.
(60) Provisional application No. 61/963,850, filed on Dec. 16, 2013.
(60) Provisional application No. 61/995,015, filed on Apr. 1, 2014.
(60) Provisional application No. 61/963,849, filed on Dec. 16, 2013.
(60) Provisional application No. 61/963,850, filed on Dec. 16, 2013.

(51) Int. Cl. H04L 29/08; G06Q 50/00; G06Q 30/02; H04L 12/58

(52) U.S. Cl. CPC H04L 67/18; H04L 51/32; H04L 67/306; G06Q 50/01; G06Q 30/0261

(57) ABSTRACT

Aspects and embodiments disclosed include services, application systems, applications, and methods for providing author information descriptive of an audience of authors. Often, the audience is defined within an identified geographic location. Additional aspects and embodiments include services, application systems, applications, and methods, for providing audience influencer information and identifying at least one influencer for an audience within an identified geographic location.

### RELATED APPLICATIONS

This application is a continuation-in-part of and claims priority under §120 to U.S. patent application Ser. No. 14/610,312, entitled “USER INTERFACE FOR PROVIDING GEOGRAPHICALLY DELINEATED CONTENT,” filed Jan. 30, 2015; U.S. patent application Ser. No. 14/610,071, entitled “SYSTEMS AND METHODS FOR ENRICHING GEOGRAPHICALLY DELINEATED CONTENT,” filed Jan. 30, 2015; and U.S. patent application Ser. No. 14/572,270, entitled “SYSTEMS AND METHODS FOR PROVIDING GEOGRAPHICALLY DELINEATED CONTENT,” filed Dec. 16, 2014. This application is a non-provisional of and claims priority under 35 U.S.C. §119(e) to U.S. Provisional Patent Application Ser. No. 62/214,369 entitled “USER INTERFACE FOR PROVIDING GEOGRAPHICALLY DELINEATED CONTENT,” filed Sep. 4, 2015, all of which applications are herein incorporated by reference in their entirety. U.S. patent application Ser. No. 14/610,312 is a Continuation in Part of and claims priority under §120 to U.S. patent application Ser. No. 14/572,270, entitled “SYSTEMS AND METHODS FOR PROVIDING GEOGRAPHICALLY DELINEATED CONTENT.” U.S. patent application Ser. No. 14/610,312 also claims priority under 35 U.S.C. §119(e) to U.S. Provisional Patent Application Ser. No. 61/995,015 entitled “METHODS FOR GEOGRAPHIC DELINEATION,” filed on Apr. 1, 2014; U.S. Provisional Patent Application Ser. No. 61/963,850 entitled “CONTENT PROVISION BY GEOGRAPHIC DELINEATION,” filed on Dec. 16, 2013; and U.S. Provisional Patent Application Ser. No. 61/963,849 entitled “METHODS OF GEOGRAPHIC DELINEATION,” filed on Dec. 16, 2013, all of which applications are herein incorporated by reference in their entirety. U.S. patent application Ser. No. 14/610,071 is a Continuation in Part of and claims priority under §120 to U.S. patent application Ser. No. 14/572,270, entitled “SYSTEMS AND METHODS FOR PROVIDING GEOGRAPHICALLY DELINEATED CONTENT.” U.S. patent application Ser. No. 14/610,071 also claims priority under 35 U.S.C. §119(e) to U.S. Provisional Patent Application Ser. No. 61/995,015 entitled “METHODS FOR GEOGRAPHIC DELINEATION,” filed on Apr. 1, 2014; U.S. Provisional Patent Application Ser. No. 61/963,850 entitled “CONTENT PROVISION BY GEOGRAPHIC DELINEATION,” filed on Dec. 16, 2013; and U.S. Provisional Patent Application Ser. No. 61/963,849 entitled “METHODS OF GEOGRAPHIC DELINEATION,” filed on Dec. 16, 2013, all of which applications are herein incorporated by reference in their entirety. U.S. patent application Ser. No. 14/572,270 claims priority under 35 U.S.C. §119(e) to U.S. Provisional Patent Application Ser. No. 61/995,015 entitled “METHODS FOR GEOGRAPHIC DELINEATION,” filed on Apr. 1, 2014; U.S. Provisional Patent Application Ser. No. 61/963,850 entitled “CONTENT PROVISION BY GEOGRAPHIC DELINEATION,” filed on Dec. 16, 2013; and U.S. Provisional Patent Application Ser. No. 61/963,849 entitled “METHODS OF GEOGRAPHIC DELINEATION,” filed on Dec. 16, 2013, all of which applications are herein incorporated by reference in their entirety.

### BACKGROUND

There are many companies that provide, consume, and transfer social networking information via the Internet, such as Twitter, Facebook, MySpace, LinkedIn, Pinterest, Foursquare, Yelp, and Tripadvisor, among others. Social networking sites allow individuals to access social media content related to business and commerce, as well as personal needs and desires. Content often includes text, photographs, videos, and audio files. Also, some social media content providers provide location-based capabilities such as, for example, permitting a user to perform actions based on location. For example, within one type of location-based social network, users are permitted to perform a “check-in” to particular locations, including venues such as businesses, retail locations, events, points of interest, or other locations. A check-in generally includes a process that identifies the user with a particular location at a given time, and may be recorded over time. Accordingly, location-based social networks permit users to find venues of interest, find content of interest, interact with friends, and leave comments regarding particular locations, among other functions.

### SUMMARY

At least one aspect is directed to a computer system including an interface configured to receive an input defining a geographic location, a location-based service including a distributed computer system having at least one processor in data communication with the interface, a delineation component adapted to aggregate geographically delineated content for an audience within the geographic location, the aggregated geographically delineated content including a plurality of social media posts each generated by an author within the geographic location, an enrichment component adapted to aggregate author profile information associated with each social media post of the plurality of social media posts, an influencer component adapted to determine influencer information for the audience based at least in part on the author profile information, and a communication component adapted to provide the influencer information.

In at least one embodiment, author information includes at least following data and the influencer component is further adapted to determine at least one influencer for the audience. In a further embodiment, the influencer component is further adapted to determine the at least one influencer for the audience based on shared followings between a first author profile and a second author profile. In at least one embodiment, the influencer component is further adapted to determine the at least one influencer for the audience based on a follower count, wherein the follower count is substantially between 1,000 and 1,000,000 followers. In a further embodiment, the influencer component is further adapted to determine the at least one influencer for the audience based on a comparison of the following information and the follower count. In a further embodiment, the comparison of following information and follower count is a ratio of following information to follower count.

In one embodiment, the computer system may further include a relation component adapted to generate an advertisement targeted to the at least one influencer for the audience. According to at least one embodiment, the influencer component is further adapted to assign an interest to the at least one influencer for the audience. In one embodiment, author information includes at least engagement information and the influencer component is further adapted to determine at least one influencer for the audience based on the engagement information. In at least one embodiment, the system is adapted to receive and store the geographically delineated content at a database, the database indexed based on a geographical mapping.

According to another aspect, provided is a computer-executed method including receiving an input defining a geographic location, aggregating geographically delineated content for an audience within the geographic location, the aggregated geographically delineated content including a plurality of social media posts each generated by an author within the geographic location, aggregating author profile information associated with each social media post of the plurality of social media posts, determining influencer information for the audience based at least in part on the author profile information, and providing the influencer information.

In one embodiment, author information includes at least following data, and the method further comprises determining at least one influencer for the audience. In a further embodiment, determining at least one influencer for the audience includes determining the at least one influencer for the audience based on shared followings between a first author profile and a second author profile. In one embodiment, determining at least one influencer for the audience includes determining the at least one influencer for the audience based on a follower count, wherein the follower count is substantially between 1,000 and 1,000,000 followers. In a further embodiment, the computer-executed method may include determining the at least one influencer for the audience based on a comparison of the following information and the follower count. In a further embodiment, the comparison of following information and follower count is a ratio of following information to follower count.

According to one embodiment, the computer-executed method may include generating an advertisement targeted to the at least one influencer for the audience. In one embodiment, the computer-executed method may include assigning an interest to the at least one influencer for the audience. According to one embodiment, author information includes at least engagement information, and the method further includes determining the at least one influencer for the audience based on the engagement information. In one embodiment, the computer-executed method may include receiving and storing the geographically delineated content at a database, the database indexed based on a geographical mapping.

At least one aspect is directed to a computer system including an interface configured to receive an input defining a geographic location, a location-based service including a distributed computer system having at least one processor in data communication with the interface, an enrichment component adapted to aggregate author information for an audience within the geographic location, the author information associated with geographically delineated content including a plurality of social media posts, each post being generated by an author within the geographic location, and a communication component adapted to provide the author information.

In one embodiment, author information includes author profile information associated with each social media post of the plurality of social media posts. According to at least one embodiment, the computer system may further include a trend component adapted to detect an incongruity from a comparison of the author information for the audience within the geographic location and an audience not within the geographic location. In a further embodiment, the trend component is adapted to detect the incongruity by comparing interest data for the audience within the geographic location and interest data for the audience not within the geographic location. In one embodiment, trend component is further adapted to filter the author information at least in part based on interest data for the audience within the geographic location. In a further embodiment, the trend component is adapted to filter the author information by parsing the interest data based on a level of descriptiveness.

According to one embodiment, the computer system may include a relation component adapted to generate an advertisement for the audience. In one embodiment, the computer system may include a relation component adapted to generate an advertisement for an author having an associated geographic location within the geographic location. According to one embodiment, the author information includes a travel history of each author within the audience, the travel history being based at least in part on a geographic location associated with a previous social media post. In one embodiment, the enrichment component is further adapted to determine a connection between at least a first author of the audience and a second author of the audience, and wherein the author information includes the determined connection.

In one embodiment, the computer system may include a delineation component adapted to aggregate the geographically delineated responsive to receiving the input defining the geographic location. In one embodiment, the input further includes at least one query parameter defining author characteristics. In a further embodiment, the system is configured to receive and store the geographically delineated content at a database, the database indexed based on a geographical mapping.

According to at least one aspect, provided is a computer-executed method including receiving an input defining a geographic location, aggregating author information for an audience within the geographic location, the author information associated with geographically delineated content including a plurality of social media posts, each post being generated by an author within the geographic location, and providing the author information.

In one embodiment, author information includes author profile information associated with each social media post of the plurality of social media posts. According to at least one embodiment, the computer-executed method may include detecting an incongruity from a comparison of the author information for the audience within the geographic location and an audience not within the geographic location. In a further embodiment, detecting the incongruity includes comparing interest data for the audience within the geographic location and interest data for the audience not within the geographic location. In a further embodiment, the computer-executed method may include filtering the author information at least in part based on interest data for the audience within the geographic location. In a further embodiment, filtering the author information includes parsing the interest data based on a level of descriptiveness.

According to one embodiment, the computer-executed method may include generating an advertisement for the audience. In one embodiment, the computer-executed method may include generating an advertisement for an author having an associated geographic location within the geographic location. According to one embodiment, the author information includes a travel history of each author within the audience, the travel history being based at least in part on a geographic location associated with a previous social media post. In one embodiment, the computer-executed method may further include determining a connection between at least a first author of the audience and a second author of the audience, and wherein the author information includes the determined connection.

In one embodiment, the computer-executed method may include aggregating the geographically delineated responsive to receiving the input defining the geographic location. In a further embodiment, the input further includes at least one query parameter defining author characteristics. In one embodiment, the computer-executed method may include receiving and storing the geographically delineated content at a database, the database indexed based on a geographical mapping.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram showing a location-based service and system suitable for incorporating various aspects of the present invention;

FIG. 2 is a block diagram showing an example process for providing author information, according to various examples;

FIG. 3 shows one example of a visualization of a geographic location, according to various examples;

FIG. 4 is a block diagram showing an example process for providing influencer information, according to various examples;

FIGS. 5A-5C show an example process flow for determining an influencer for an audience, according to various examples;

FIG. 6 shows an example computer system with which various aspects of the invention may be practiced; and

FIGS. 7-14 show example user interfaces, according to various examples.

### DETAILED DESCRIPTION

Aspects and embodiments disclosed herein include services, application systems, applications, and methods for providing author information descriptive of an audience of authors. Often, the audience is defined within an identified geographic location. Additional aspects and embodiments include services, application systems, applications, and methods, for providing audience influencer information and identifying at least one influencer for an audience within an identified geographic location. While traditional social media platforms offer tools that allow users to generate social media posts and exchange information, content, and ideas, such shared content offers limited insight to the authors that generate the content, and the influencers that have an impact on decisions those authors make. It is appreciated that this author information has substantial value not only for personalized advertisements, offers, solicitations, and notifications, but it may also be used to improve relationships between one or more social media users, create connections between social media users, provide more accurate and relevant information, and generally improve a social media user experience.

For example, such a system that aggregates and indexes social media content having an associated geographic location (i.e., geographically delineated content) may be adapted to analyze posted content in order to determine author information. Such a system may generate advertisements, instruct an advertising system to generate advertisements, or instruct a content provider to generate advertisements, based on the determined author information. Furthermore, the system may analyze the author information and determine one or more influencers that influence decisions that particular authors make. Such a system may instruct an advertising system or content provider to generate and send advertisements to the one or more identified influencers.

In various embodiments, systems described herein may aggregate geographically delineated content from one or more social media content providers. As used herein, geographically delineated content can include social media content or social networking information that is relevant to one or more geographic locations. In various embodiments, geographically delineated content includes a plurality of social media posts (referred to herein as “posts” or “media posts”). Each post is respectively generated by an author, which may include a user or client, through a social media content provider. For example content can include text, photographs, videos, hyperlinks, audio files, among other data types. Content can be generated through one or more social media content providers, online repositories of information, or any other provider of location-based relevant content. Although social media content providers, as described herein, include social media platforms such as Twitter, Facebook, MySpace, LinkedIn, Pinterest, Foursquare, Yelp, and Tripadvisor, in further embodiments, providers can include any social media content provider as is understood in the art (including any media that is produced by a human (user generated content), which may not necessarily be considered social media content or platforms).

Content is generated by any source of content such as social media platform users, companies, or any other source of social media content. Sources of content may permit an author to generate individual media posts including text, image content, hyperlinks, audio files, hashtags, likes, dislikes, @mentions, image content, tagged venues/places, and author information including: age, sex, topic interests, and domicile. For example, a media post may include a tweet having an avatar, a username, the author's name, a number of likes, the date of the media post, a photograph, and one or more hashtags. Authors may include any person or entity that composes a social media post.

Content may be storedby one or more computer systems. One aspect of the disclosure relates to an improved computer system that indexes and aggregates, locates social media context. Certain aspects relate to user interface functions that permit a user to more efficiently locate and navigate such content.

In various aspects, geographic locations associated with media posts can refer to a country, a state, a city, a neighborhood, a building, a venue, an address, coordinates such as longitude and latitude, or any other information descriptive of a location. Although geographic location as used herein includes a single geographic location, in various embodiments, geographic location can include a plurality or a series of locations. In various embodiments, media posts within geographically delineated content include an attached (“tagged”) geographic location.

As described above, in some embodiments this can include a “check-in” to particular locations, including venues such as businesses, retail locations, events, points of interest, or other locations. A check-in generally includes a process that identifies the author with a particular location at a given time, and may be recorded over time. In other embodiments, the geographically delineated content is automatically tagged with a geographic location. For example, geographically delineated content generated from a content provider device having a Global Positioning System (“GPS”) may automatically embed location information in the generated content.

In further embodiments, a social media platform may allow an author to manually enter location information. While some content providers may not provide a location with generated content, location may still be inferred from intrinsic information, such as metadata associated with the content. It should be appreciated that geographically delineated content should not be limited to content tagged with a geographic location in any particular manner. Accordingly, it is appreciated that various media posts and types of content will not have location information inherently associated therewith. As such, conventional systems cannot search and provide such information by geographic location. According to one aspect of the present invention, a system may be provided that enhances such information to include additional information that can be inferred by analyzing other content that is determined to be related to the media post not having a geographic location. In this way, metadata associated with content may be improved over the original posted versions.

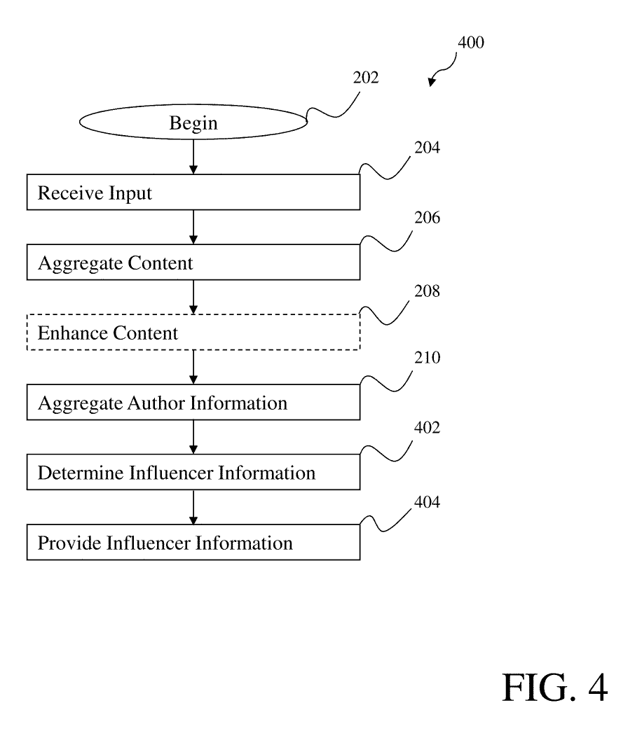

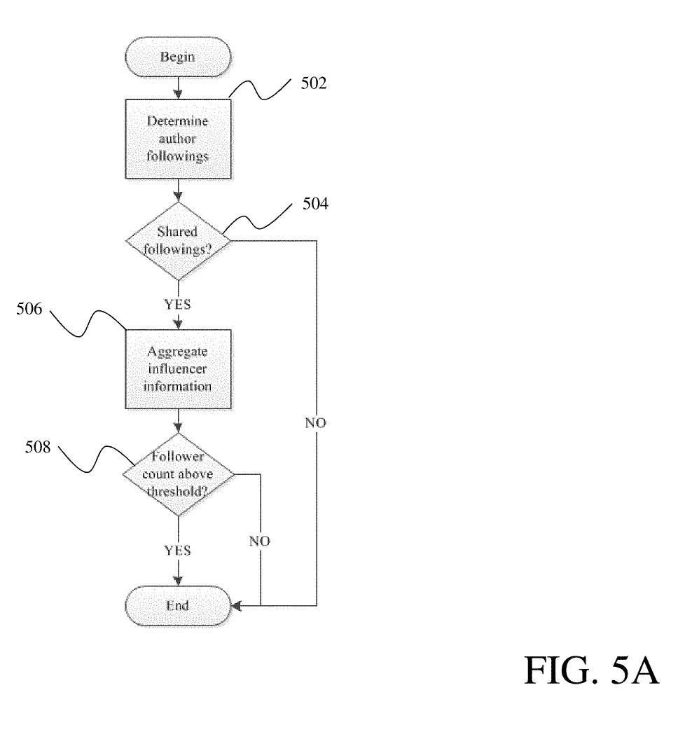

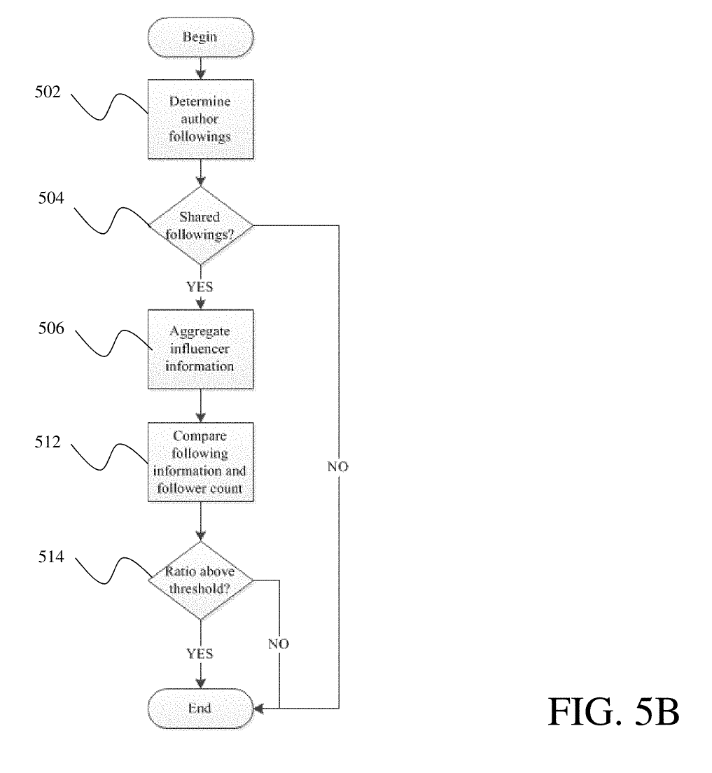

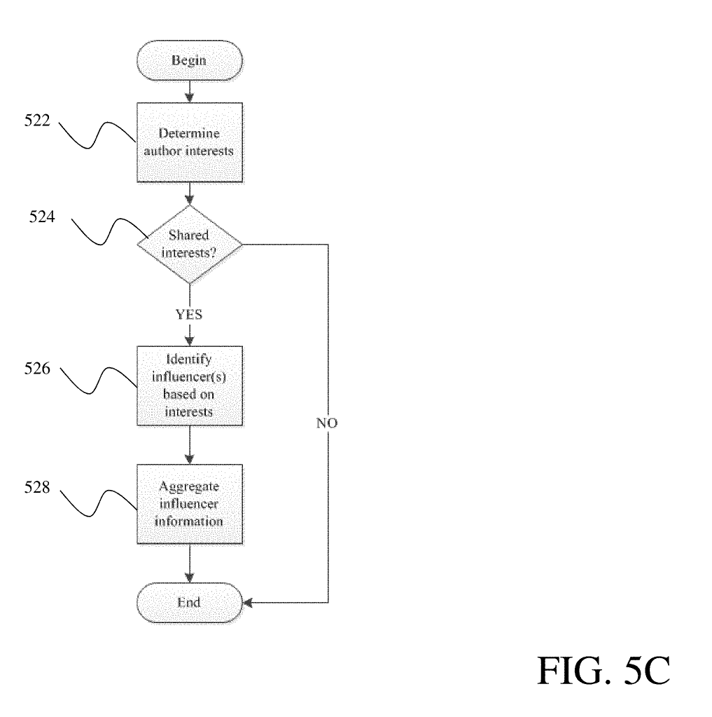

As described herein, influencers may include individuals, characters, groups, organizations, businesses, and any other entity that has the power to effect actions or inactions taken by another as a result of their perceived relationship, authority, knowledge, status, position, association, or charisma. While influencers are described herein primarily in the context of influencing purchasing decisions, in various implementations influencers may include those who influence any action or inaction, such as attending an event, accessing information (e.g., news articles and educational material), performing an activity, and etc. In particular, various influencers described herein include social media influencers having a social media reputation or influence. Various aspects and embodiments including and related to influencers, and in particular, social media influencers are described herein with reference to FIGS. 4 and 5A-5C.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Moreover, it is to be understood that both the foregoing information and the following detailed description are merely illustrative examples of various aspects and embodiments of the present invention, and are intended to provide an overview or framework for understanding the nature and character of the claimed aspects and embodiments. Any embodiment disclosed herein may be combined with any other embodiment in any manner consistent with at least one of the aspects disclosed herein, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearance of such terms herein is not necessarily all referring to the same embodiment.

Furthermore, in the event of inconsistent usages of terms between this document and documents incorporated herein by reference, the term usage in the incorporated references is supplementary to that of this document; for irreconcilable inconsistencies, the term usage in this document controls. In addition, the accompanying drawings are included to provide illustration and a further understanding of the various aspects and examples, and are incorporated in and constitute a part of this specification. The drawings, together with the remainder of the specification, serve to explain principles and operations of the described and claimed aspects and examples.

### Location-Based Systems and Processes

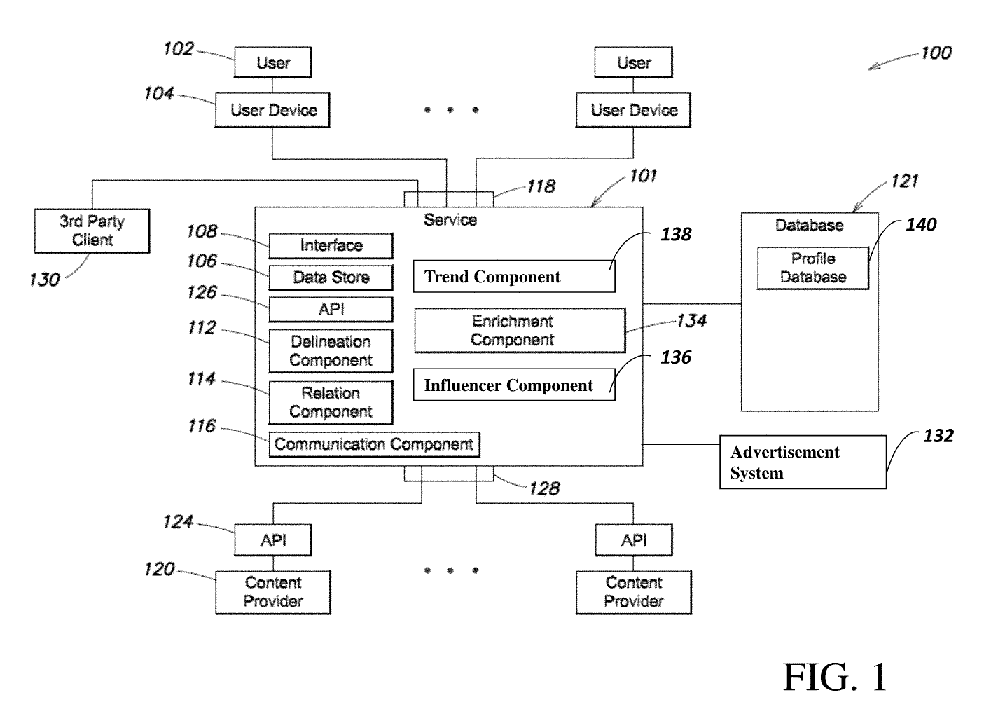

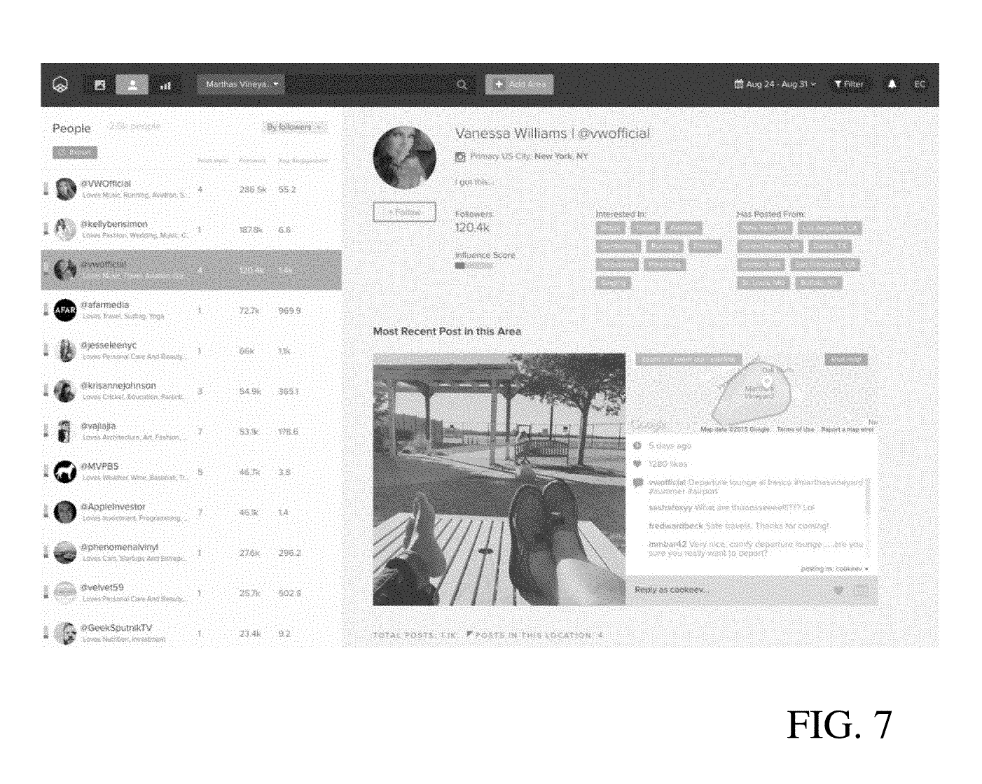

Turning now to FIG. 1, a block diagram of a location-based service and system suitable for incorporation of various aspects of the present invention is shown. For instance, the service 101 may permit one or more users (e.g., user 102) to request and receive author information and/or influencer information for an audience based on an input defining a geographic location. In various embodiments, the author information is associated with geographically delineated content including a plurality of social media posts each generated by an author within the geographic location. In further embodiments, the service 101 may also permit a user 102 to find an influencer for an audience within an identified geographic location. In one example, such features permit the service 101, or an advertisement system 132 in communication with the service 101, to generate and tailor advertisements to targeted users, authors, an audience, or influencers. In various embodiments, geographically delineated content, author information, and/or influencer information, may be provided to the user 102 in a visual display permitting the user 102 to filter, sort, navigate, and otherwise interact with the content and information in a more efficient way. Content and information may be displayed on an image of the geographic location, such as a map visualization, and in one or more user interfaces as discussed below with reference to FIGS. 7-14.

As shown, in one embodiment, the system 100 can include a computing device (e.g., user device 104) having a memory, a user interface, and one or more processors. For example, the user device 104 can include a cell phone, smart phone, PDA, tablet computer, laptop, or other computing system. Users 102 may use the interface of the user device 104 for interacting with the system 100. In other embodiments, the service 101 may permit one or more third party client systems (e.g., client 130) to request and receive geographically delineated content, author information, or influencer information associated with an input.

In one embodiment, the service 101 may include one or more components. Such components may be implemented using one or more computer systems. In one embodiment, service 101 may be implemented on a distributed computer system using one or more communication networks (e.g., the Internet). In one implementation, the service is implemented in a cloud-based computing platform, such as the well-known EC2 platform available commercially from Amazon.com, Seattle, Wash. Other implementations are possible and are within the scope and spirit of the invention, and it is appreciated that other platforms may be used.

Service 101 may include a webserver which is capable of serving as a front end to the location-based service 101. User devices 104 and/or clients 130 may receive and display geographically delineated content, author information, and/or influencer info associated with geographically delineated content, aggregated and provided by the service 101. Notably, devices 104 and clients 130 may include controls that perform various functions in an application (e.g., a mobile application). Further, such devices 104 and clients 130 provide an input generated by the user 102 or the client 130. The user, or client, input may be used to perform one or more functions, such as defining a geographic location, defining author characteristics, or defining content characteristics.

Service 101 may also provide one or more related services, such as a service for providing location-based social media content, author information, and/or influencer information, associated with location-based social media content. Services may be integral to service 101 or may alternatively operate in conjunction with service 101 (e.g., by communicating with the service 101 through an Application Programming Interface (API)). In some implementations, the service 101 is configured to execute one or all of a plurality of components including a delineation component 112, a relation component 114, a communication component 116, an enrichment component 134, a trend component 138, and an influencer component 136. In further embodiments, the service 101 may include means for performing any or all of the processes described herein. Components may be implemented using specialized hardware, software, or a combination thereof.

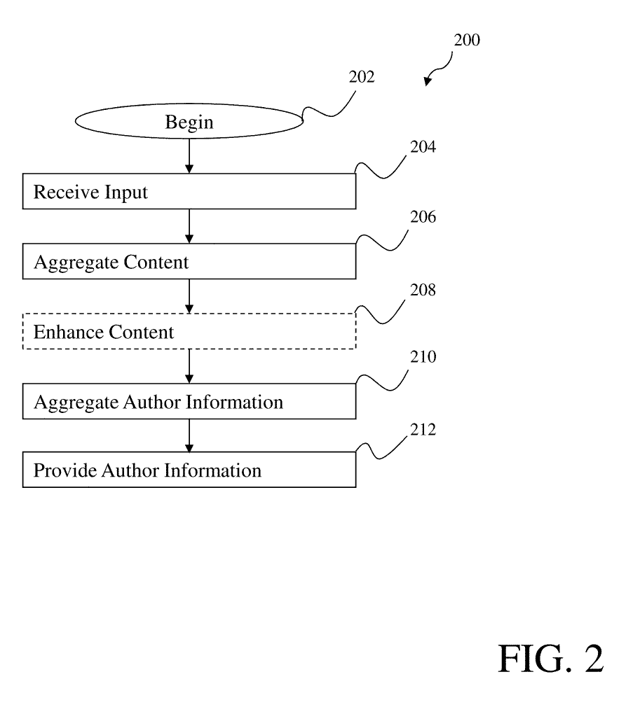

With continuing reference to FIG. 1, FIG. 2 shows an example computer-executed process (e.g., process 200) in accordance with at least one embodiment. At block 202, the process 200 begins. At block 204 an input is received from a user or a client, over a network 118. The interface 108 of the service 101 is configured to receive from the user device 104, or the client 130, the at least one input. In one embodiment, the input defines a geographic location for which to aggregate and provide content, author information, or influencer information.

In various implementations, the input may include a selection from a list of geographic locations, a selection of a geographic location defined in a visual geographic representation of a geographic location (e.g., a map), or a natural language-based identification of a geographic location (e.g., keywords). For example, the user interface may be configured to receive as an input: a country, a state, a city, a neighborhood, a building, a venue, an address, coordinates such as longitude and latitude, or any other information descriptive of a location. The interface may also be configured to receive a polygon defined in a visual geographic representation of a geographic location. In this embodiment, the interface 108 is configured to provide a tool to permit the user or client to define (e.g., draw) the polygon. In further embodiments, the service may automatically adjust or make adjustment suggestions to a user input responsive to receiving the user input. Such implementations permit the user to define the most accurate and relevant geographic location.

In some embodiments, the input may also define one or more query parameters specifying the type or characteristics of the geographically delineated content, author information, or influencer information desired. The query parameters may be selected from a list (or other visual presentation) or entered by the user as keywords. For example, author characteristics may specify requested author information, influencer characteristics may specify requested influencer information, and content characteristics may specify the type or topic of requested geographically delineated content. As mentioned above, author information may include any information descriptive of an author of social media content, such as any information describing an author on a social media platform. For example, author information may include: the author's display name, the author's username, the location of the author, the author's website, the author's biography, the author's source application URL, the author's following count, a count of how many authors are following the author (i.e. follower count), the names of those the author is following, the author's total post count, the author's post count in a geographic location, how many impressions the author has, the author's influence score, age, gender, interests, domicile, occupation, date of birth, the school that the author has or is attending, the author's relationship status, approximate income, and recent activity, travel history, to name a few.

Similarly, influencer information may include any information descriptive of an influencer, and in particular, a social media influencer. In several implementations, influencer information may include: the influencer's name, the influencer's display name on a social media platform, the influencer's username, the location of the influencer, the influencer's website, the influencer's biography, the influencer's source application URL, the influencer's follower count, a count of how many authors are following the influencer, a count of how many influencers are following the influencer, the influencer's total post count, the influencer's post count in a geographic location, how many impressions the influencer has, the influencer's influence score, age, gender, interests, domicile, occupation, date of birth, the school that the influencer has or is attending, the influencer's relationship status, approximate income, sponsorships, endorsements, recent activity, travel history, and any connections the influencer has to other influencers, to name a few. While discussed herein in several embodiments as separate from author information, in additional embodiments, author information may include influencer information or influencer information may include author information. For example, influencer information may include author information associated with an author profile of a particular influencer. Influencers may be scored or rated against each other to determine their influencer value.

In one embodiment, the service 101 may store information for each particular user or client, including inputs or preferences defining a geographic location. Specifically, after receiving the input via the interface 108, the user 102 or client 130 may activate a save indicator prompting the service 101 to store the entered input at a data store 106. In further embodiments, the service 101 may store author information, influencer information, or geographically delineated content for a geographic location responsive to user input indicating that such content and/or information should be saved. In various embodiments, the user 102 or client 130 can label or otherwise “name” stored data or information. Stored inputs can be associated with user accounts and recalled from the data store 106. For example, the service 101 can be configured to associate a stored input with a unique identifier associated with a user or client account. The service 101 can then be configured to aggregate and provide author information, influencer information, and geographically delineated content relating to the unique identifier.

It is appreciated that users of the systems, methods, and services described herein may be interested in authors generating content within the same geographic location over periods of time, for example, the user 102, or client 130, may make the same request for author information three times a week. Similarly, a user 102 or client 130 may be interested in author information regarding new authors that enter or leave the same geographic location (e.g., potential customers walking within a predetermined distance of a store located within the geographic location). Accordingly, the service 101 permits the user 102, or client, to store entered inputs for efficiency and convenience. It is further appreciated that as the audience of authors within a geographic location changes, the influencers relevant to that audience change as a result.

At block 204, a website or application (e.g., application executing on the user device 104) may be displayed to the user 102. Alternatively, an interface such as an API (e.g., API 126) may be provided to an application for providing the input to another application or system, such as the client 130. As discussed above, the input may be received at the interface 108 of the service 101. Also, the input may be received from a third party application or system that utilizes location-based services.

A component within the service 101 is configured to communicate with at least one source of content, such as a content provider 120, and/or a database (e.g., database 121) to perform a query. In various embodiments, the system 100 may include a plurality of databases, each database storing geographically delineated content, author information, or influencer information. While in one embodiment performing a query includes requesting social media content from a content provider, (e.g., Twitter), in other embodiments it includes requesting content from the database 121. Content and information may be stored and indexed as further described below.

In one embodiment, responsive to receiving the input, the delineation component 112 generates a query compatible with the one or more content providers 120 or the database 121, based on the geographic location and the query parameters. For example, the query can be formatted to request geographic delineated content from one or more content provider APIs 124. The APIs 124 associated with one or more content providers 120 permit the exchange of geographic delineated content. However, in other various implementations the delineation component 112 is configured to generate a query for the content provider without using an associated API. It is appreciated that various content provider APIs may have different limitations and accordingly, in various implementations, the query is formatted specifically for each content provider.

In one embodiment, a content provider 120 is queried by specifying a geographic point, for example a longitude and latitude, and designating a radius around that point. Additionally, a time period, or other criteria, may be specified. Although described above as performing one query, in various embodiments the delineation component 112 is configured to perform multiple queries in response to receiving a client or user input. For example, the delineation component 112 can be configured to perform a second, a third query, and others of a series of queries of any number to ensure that all areas of the geographic location are covered.

The service 101 may also be capable storing information in one or more content databases prior to receiving a user or client input. Such an implementation permits the service 101 to query the database instead of, or in addition to, a content provider. This increases the speed and efficiency of the service 101. For instance, the service 101 may be configured to gather and store geographically delineated content (e.g., location based social media content), such as text, photographs, videos, audio files received from at least one content provider 120, and any author information, continually, periodically, or intermittently. Accordingly, in some examples the service 101 may not need to query the content providers 120 as relevant content and information may be readily available at the database 121. For instance, for a particular geographic region or location, the service 101 may automatically receive a feed of all content for that region or location, and store seller information within a database (e.g., database 121).

In one implementation, received content is stored and indexed in a geographic quadrant based storage grid. When visualized, the grid resembles a mesh placed over the planet(e.g., Earth), in which grid lines run parallel to longitude and latitude lines. Accordingly, received geographic content is stored in location-based quadrants related to the tagged location of the content. In other embodiments, geographically delineated content is stored in a time-based grid, in which content is stored based on the time the content was generated by the content provider. In other embodiments, content can be stored in a time-received-based grid, in which content is stored based on the time the geographic content was received by the delineation component. In further embodiments, the received content can be stored in a subject-based grid, in which content is stored based on the source or the type of the geographically delineated content (e.g., Twitter, Facebook, MySpace, LinkedIn, Pinterest, or Tumblr content). It should be appreciated that geographically delineated content can be stored in any other fashion as is suitable for geographically delineated content.

In various embodiments, one or more components of the service 101 are configured to automatically generate datum content responsive to receiving geographically delineated content from one or more content providers 120. For example, datum content may correspond with the source content of each individual media post within the received geographically delineated content. Datum includes a concentration of the bare minimum information necessary to support a search and analysis of stored geographically delineated content. For example, while full image metadata may be stored in a source document, the associated datum document only contains a list of metrics, otherwise referred to as feature names, e.g., “author,” “sport,” etc. The datum content reduces the file size and concentrates contents of the datum document to permit the service 101 to efficiently and rapidly convert a query against the datum content and aggregate geographically delineated content. In this way, the speed of queries is improved, and delineated content may be efficiently aggregated. As understood, file size refers to the amount of space consumed by a file, such as a datum document. Typically, file size is measured in bytes. It should be appreciated that a prohibitively large number of media posts may be generated by multiple users of various social media content providers that could be retrieved by a particular service. Because of the large numbers of items that could be queried, viewed, etc., by a system, a more efficient method of working with such items may be necessary. For instance, even within a defined geography, there may exist too many source documents to be processed effectively.

Additionally, maintaining a full set of source content, permits the service 101 to further analyze the source content, debug the process, and perform other maintenance operations. One or more components can additionally be configured to denormalize key information into the datum content to optimize queries and analysis, for example, author information including username, follower count, avatar, author bio, etc. Such an embodiment permits the service 101 to perform one or more of the aspects discussed below, such as detecting high influence authors or filtering geographically delineated content.

For example, a media post may include all of the information associated with a self-taken Instagram picture posted at Gillette Stadium in Foxborough, Mass. during a professional football game. Generation of the datum document (referred to herein also as story datum) can include analysis of the metadata, information, or other data associated with the post that may suggest the topics, sports, football, rugby, and soccer. However, only “sport” and “football” are included in the datum document, as rugby and soccer are not relevant to a professional football game. The datum document also includes “person”, as included in the picture were facial features.

The datum may also include hashtags, and location information. In one embodiment, the datum may include different types of location information that are indicative of the source of the location information or otherwise indicate how the location information should be used by the system. For instance, as referred to herein, the system may define and use genuine or precise location information. As used herein, genuine location refers to a referential geographic position, such as a venue or store location, and precise location refers to navigational positioning, such as GPS location or longitudinal and latitudinal coordinates. Accordingly, in this example, the datum would include parameters indicating values, such as, for example, genuine location true and precise_location false. Because the picture was taken at Gillete Stadium, the genuine location is included, but the precise location is not.

Based on the foregoing, the media post may be included in all queries and analysis of geographically delineated content associated with the Gillete Stadium. In various embodiments differentiating between genuine location and precise location can include or exclude media posts displayed in a visual representation. Omitting media posts not having a precise location for a visualization of a geographic location prevents the build-up of artificially inflated “hotspots” of content for a particular discrete point within the identified location. Although described herein generally as aggregating geographically delineated content responsive to querying a geographically delineated content database, in various embodiments, querying a database includes identifying a story datum document and converting the query to return source content including one or more media posts. Datum content may be stored in any manner as described herein, such as in a geographic quadrant based storage grid. It should be appreciated that some or all of this datum content and its functionality may be made available to one or more clients directly, or be provided to a third party system (e.g., via an API).

As such, in various embodiments, the delineation component generates a query compatible with the database 121. Querying database 121, instead of the content providers 120, or in addition to the content providers 120, offers numerous benefits such as improved speed, precision, and accuracy. Furthermore, such process permits content enhancement as is described herein. The delineation component 112 may be configured to query one or more content providers 120 and receive geographically delineated content automatically to ensure an accurate and updated database of content. In one embodiment, the delineation component is configured to continually query content providers for content relative to frequently requested geographic locations. For example, the delineation component 112 can be configured to automatically and continually query and aggregate geographically delineated content from Twitter in the Boston, Mass. location. Automatic queries may be time scheduled, may be random, or may be variable based upon the activity within a particular geographic location. In various embodiments, the frequency and range of automatic queries and aggregations are based on the frequency and/or volume of user or client inputs. In other embodiments, the frequency and range of automatic queries are based on social events (e.g., concerts, sport events, weather, news stories, etc.).

In some embodiments, the delineation component 112 is further configured to delay, postpone, or “put to sleep” automatic queries. For example, the delineation component 112 may delay automatic queries for infrequently requested geographic location. In this regard, the service 101 can determine whether content requested from a particular location will likely be requested, and delay the query and aggregation if necessary. Delay, postponement, and “put to sleep” configurations permit the service 101 to allocate computing resources. Although discussed herein as performed by a delineation component 112, in various other embodiments, querying one or more content providers 120 and aggregating geographically delineated content may be performed by a plurality of components.

At block 206, the delineation component 112 is configured to aggregate the geographically delineated content received from the query. In response to performing the query, the delineation component 112 aggregates the geographically delineated content having an associated geographic location within the geographic location. Content may be retrieved from the database 121 and/or one or a plurality of content providers 120, as discussed above, and may be in one or a plurality of formats. Content can include text, photographs, videos, and/or audio files, and in additional embodiments, enrichments.

At block 210, the delineation component is configured to analyze the aggregated geographically delineated content and aggregate author information. For example, author information may be extracted from individual media posts of the geographically delineated content, aggregated from author profiles stored at the database 121, or aggregated from one or more author accounts on various social media platforms, such as Twitter, Facebook, MySpace, LinkedIn, Pinterest, Foursquare, Yelp, Tripadvisor and Tumblr, among others.

In several embodiments, author information includes information associated with an author profile of the author that generated a respective media post of the aggregated geographically delineated content. Author profiles may be generated by the service 101 and stored in one or more databases, such as a profile database (shown as 140 in FIG. 1). In various embodiments, responsive to aggregating geographically delineated content, one or more components of the service 101 are configured to analyze each of the plurality of media posts and determine an author responsible for generating the media post. This can include analyzing any of an avatar, a username, a full name, a bio, a profile picture, or any other characteristic available in a media post or on an author's profile at a platform of a social media content provider. In particular, the enrichment component 134 can be configured to realize an identifier associated with a profile having author information and other enrichments as described below. For example, in various embodiments this may include identifying a username associated with a social media post and querying an author profile stored within the database 121 based on the identified username. Profiles may include repositories of metadata extracted from previous posts, information available on other social media platforms, and information available from any other appropriate source.

Responsive to identifying the author, a corresponding author profile can be identified, and author information not included in the media post may be aggregated. For example, a media post within the plurality may include the author's name and an avatar associated with a particular social media content format and platform. While helpful, this information is limited and may not provide a full story about the author. For example, this information does not provide any additional insight as to whether the author has a profile on other social media platforms. Accordingly, aggregating author information can include aggregating the author's date of birth, the school that the author attended, the author's interests, the author's relationship status, gender, age range, local location, recent activity, mutual connections, general activity, travel history, or any other author information discussed herein that is not included in the media post.

In some embodiments, no author profile may exist at the database 121 for an author associated with a media post. Often this is the case when a new author is identified. Accordingly, in various embodiments one or more components of the service 101 are configured to generate and store an author profile. Author profiles are generated by aggregating information, data, metadata, and information descriptive of author characteristics. As described above, author information can be ascertained from one or more media posts or a corresponding profile at one or more social media content provider platforms. For example, content providers may include social media and social networking providers such as Twitter, Facebook, MySpace, LinkedIn, Pinterest, Foursquare, Yelp, Tripadvisor, and Tumblr.

The information may be arranged and stored as the author profile. Author profiles, may be generated and updated automatically when the service 101 receives geographically delineated content. For example, in various embodiments, responsive to identifying an author and determining an author profile for that author is not available at the database 121, the service 101 is configured to query one or more social media content providers 120 to determine an avatar, profile photograph, username, full name, bio, website, location, date joined, verification status, activity, number of followers, favorites, education, sentiments, connections, age, employment status, employer, relationship status, date birth for the author, gender, or any other author identifying characteristics for that author. The determined characteristics are added to the information ascertained from the media post and stored in a new author profile accordingly. Author profiles may be uniquely defined in a database (e.g., in database 121).

In various embodiments, one or more components of the service described herein are configured to update the author profile with each media post received. For example, an update may occur when a media post indicates that an author's interests have changed. Furthermore, author profiles may be updated responsive to detecting new information at a user profile on a social media content provider platform. Updates may be performed automatically to ensure accurate and truthful author profile information aggregated from the author profiles. Notably, the author profile provides a centralized repository of author information across all social media content provider platforms. Because an author can be identified across multiple social media platforms, social activity of the author may be more effectively measured in comparison to measuring activity over a single channel (e.g., Twitter).

Further still, in some embodiments, a media post of the plurality of media posts may not have a profile name, user name, or other author information, from which an associated author may be easily identified. Accordingly, one or more component of the service 101, such as the enrichment component 138, may be configured to further analyze metadata associated with the media post to determine the author profile associated with the author despite the absence of an identifier for the author profile. For example, such an identification may include identifying an @mention or analyzing a photograph to determine facial features of the author. As such, in various embodiments one or more components are configured to analyze information, data, metadata, or meta information associated with the plurality of media posts of the aggregated geographically delineated content to identify an author profile and aggregate author information, such as author profile information.

At block 212 of FIG. 2, the communication component 116 is configured to provide the aggregated author information and/or geographically delineated content to the one or more user devices (e.g., user device 104) or clients (e.g., client 130) permitting the respective user or client to view the information and/or geographically delineated content. In further embodiments, the communication component 116 may also distribute user or client generated inputs, author information, or geographically delineated content, to social networking sites, social media content providers, or an advertisement system.

In various embodiments, one or more components of the service 101, for example the enrichment component 134, may enrich (i.e., enhance) geographically delineated content (act 208). In various embodiments, content may be enriched automatically upon receipt from a content provider 120. It is appreciated that enriched aggregated geographically delineated content benefits the user, or client, by permitting real-time access to more content, more relevant content, and detailed social media content across multiple social content provider platforms. Accordingly, users receive more robust and interconnected aggregations of content. Various embodiments also permit more efficient, swift, and detailed user queries to return more relevant content. For example, often media posts received from Twitter will not include a location. In various embodiments, enrichment data including location information may be associated with the Twitter post. As such, users not only receive more detailed information, they will receive content that would not have otherwise been detected or found.

For example, individual media posts of the plurality of media posts may be deconstructed into a plurality of dimensions, such as an author dimension, an image dimension, a content dimension, and a location dimension. Each dimension may be enhanced with enrichment data to provide a more robust aggregation of geographically delineated content. Generally, dimensions include divisions of information, data, and meta information intrinsic to the media post. For example, the author dimension of a media post may include an avatar and a username of the author that generated that media post. One or more components of the service may be configured to automatically aggregate enrichment data related to at least one of the dimensions of each of the individual media posts. In various embodiments, aggregating enrichment data includes analyzing the dimensions of each individual media post. In particular, the enrichment component 134 can be configured to realize an identifier associated with a profile having enrichment data, as discussed above. In addition to author information, profiles may include repositories of other metadata extracted from previous posts and may include venue information, content information, location information, event information, or any other information not provided by the content provider from which the media post is provided.

As discussed herein, enhancing at least one of the individual media posts includes adding, exposing, identifying, or otherwise providing information, data, metadata, or meta information not inherent to the associated media post. It is appreciated that often a content provider 120 will not provide a full story associated with a media post. For example, in various embodiments, enhancing the plurality of media posts includes providing a visualization of enrichment data to present a more robust narrative of the story told by the media post. Enhancing the plurality of media posts, can include providing additional data related to at least one of an author dimension, a content dimension, a location dimension, or an image dimension. In further embodiments, enhancing the aggregated geographically delineated content with enrichment data permits the service to categorically group related media posts that would not have otherwise been identified as related.

In various embodiments, one or more components of the service 101, such as the trend component 138 may be configured to perform one or more processes or algorithms based on at least the aggregated author information. For example, the trend component may be configured to detect an incongruity from a comparison of one or more aggregations of author information. As used herein, incongruities may include any inconsistency in author information between a first audience and an additional audience. The additional audience may be as large as the entire world or as small as a neighborhood, town, or city. The geographic location of the additional audience may be automatically determined by one or more components of the service, or defined responsive to a user input specifying the geographic location.

For example, in at least one embodiment the aggregated author information may include interest data. Interest data may be composed of data corresponding to interests of each author responsible for a post within the aggregated geographically delineated content. Author interests may include any specific item in which the author is interested. Interests may include anything that engages, excites, or garners the attention of an author. For example, interests may include, hobbies, activities, social or familial groups, objects, and locations. Such interest data may be received from multiple social media platforms and aggregated by one or more components of the service 101. The service 101 is configured to identify from the aggregated author information individual interests for each author within the audience. In particular, one or more components of the service 101 performs machine learning, such as Natural Language Processing (NLP) or computer vision, to analyze the author information for related topics. While in some embodiments, this may include extracting interests directly from geographically delineated content, often it includes identifying an author profile associated with each author, the profile having previously identified interests. In various embodiments, this may include referencing an author profile stored at the database 121. In other embodiments, identifying an author profile includes identifying an author profile associated with one or more social media platforms. Each author profile may list previously identified interests of the author.

In various embodiments, the trend component 138 is configured to detect an incongruity by comparing interest data for the audience within the geographic location and interest data for an audience not within the geographic location. This may include comparing audiences within two defined geographic locations, or comparing interest data of an audience within the user defined geographic location to interest data of the entire world. Such a comparison provides a gauge of the unique interests of an audience, and in particular the unique interests of authors within a particular geographic location. For example, responsive to receiving an input defining the Boston, Mass., geographic location, and aggregating author information for authors within that location (i.e., the audience), one or more components of the service 101 may compare the interests of those authors with the interests of authors within the New York, N.Y., location. Such a comparison, may provide that authors within the Boston, Mass. geographic location have more of an interest in Skiing, Ice Hockey, Wine, and Motorcycles, and less of an interest in Running, Basketball, Craft Beer, and Jazz Music. These incongruities, detected from the comparison may be provided to the user as percentages, graphs, charts, listings, or any other appropriate display. In one embodiment, incongruities are provided based on a ranking or score. The ranking or score may indicate the strength of the interest based on a numbered scale, where a mean number indicates and average value of interest.

In another example, responsive to receiving an input defining the Boston, Mass., geographic location, and aggregating author information for authors within that location (i.e., the audience), one or more components of the service 101 may compare the interests of those authors with a mean level of interests for the entire world. For instance, this may include comparing the author information of the audience to all author information stored in the database 121. In various embodiments, the comparison may include comparing the volume of authors associated with a particular interest. This comparison may indicate that compared to other geographic locations around the world, authors within the Boston, Mass., geographic location have more of an interest in interest in Skiing, Ice Hockey, Wine, and Motorcycles, and less of an interest in Running, Basketball, Craft Beer, and Jazz Music. Various embodiments permit the user or client to adjust the size or shape of the compared geographic locations, for example via the user interface. As described herein, users may expand, narrow, or otherwise adjust the entered geographic location. Similarly, users may expand, narrow, or otherwise adjust the compared geographic location.

Various embodiments may also provide one or more filters that group, parse, remove, and filter provided author information, and in particular, interest data. In at least one embodiment, users may filter through interest data for a given audience, starting at a high level of generality and narrowing to a specific area of interest. Interest data may be arranged in a hierarchical structure according to a level of specificity of the interest. Display of author information initiated by a user input is dependent upon the current location of the user in the structure, as is the information provided. Nodes within the hierarchical structure may be predetermined or automatically determined by the service 101. For example, a first node of the hierarchical structure may include the interest “Sports.” At this level of the structure, all author information including interest data related to “Sports” is provided to the user or client. Any author information not including interest data related to “Sports” is filtered and not provided. This may include any author information associated with an author that has an interest in Baseball, Football, Tennis, Ice Hockey, Basketball, etc. The service 101 then may permit the user to further filter the provided author information by selecting an input corresponding to a second node. For example, the second node may include the interest “Ice Hockey.” At this level of the structure, all information including interest data related to “Ice Hockey” is provided to the client, and any author information not including interest data related to “Ice Hockey” is filtered. The service then may permit the user to further filter the provided author information by selecting an input corresponding to a further node, such as “Boston Bruins.” Accordingly, various aspects and implementations of the service 101 filter author information based on particular interests of authors within a geographic location. Such a system permits the creation of more personalized and relevant offers and advertisements. For example, author information may be filtered to the lowest level of a particular interest, revealing only those authors interested in that particular interest. Targeted advertisements may be generated for those authors, improving the speed, efficiency, and accuracy of known systems.

In various embodiments, the relation component 114 may generate a visualization from the aggregated geographically delineated content and/or author information. For example, the visualization may include an image of the geographic location. For example, the image may include a street map, a satellite image, a mass transit map, or a geographic depiction. In various embodiments the visualization may include a heatmap of the provided geographically delineated content and/or author information. As used herein, one embodiment of a heatmap visualization refers to a volume-based depiction. Individual posts may be displayed by associated location within the visualization, or displayed as one or more groups of content or information.

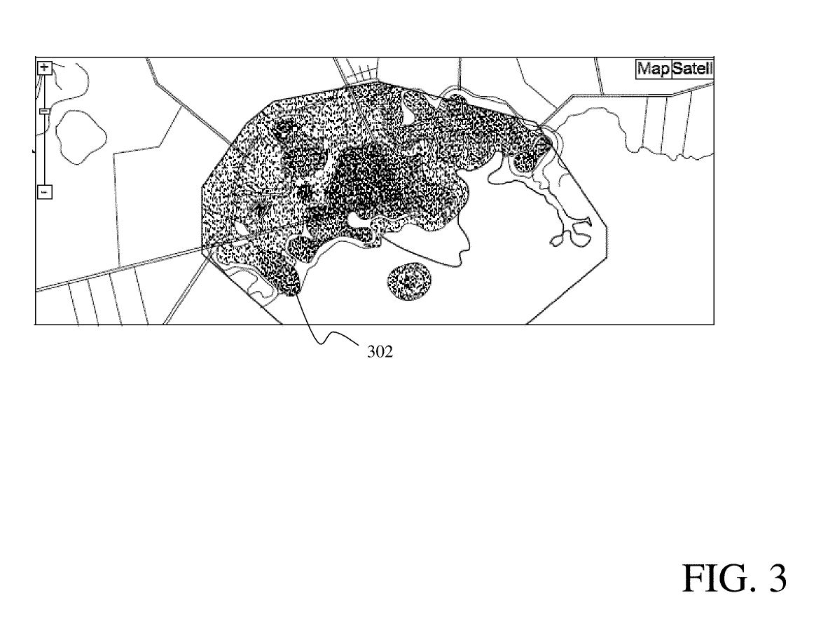

The heatmap visualization may further include one or more indicators layered over the image of the geographic location. The indicators are configured to show the density of the volume of the geographically delineated content for a geographic location, or a series of locations, on the image and can include but should not be limited to colors, shapes, and images. In one implementation, the heatmap visualization shows a range of colors conveying the volume of social media content in the geographic location to help the user or client understand the geographic layout of social media content or activity. For example, a heatmap visualization for the geographic location of Boston, Mass., may show a higher volume of Twitter content in the North End neighborhood than the South End or South Boston neighborhoods. FIG. 3 shows one example of a heatmap visualization. The heatmap visualization of FIG. 3 shows one or more indicators 302. The indicators 302 are configured to show the density of the volume of the geographically delineated content or author information for a discrete spatial area. As shown, the indicators 302 include a range of colors conveying the volume of social media content in the geographic location to help the user or client understand the geographic layout of social media content or activity.

While in several embodiments aggregated author information for the audience may be provided directly to the user or client, or enhanced and provided to the user or client, in additional embodiments, one or more components of the service 101, such as the influencer component 136, may be configured to execute a series of instructions to determine and provide influencer information associated with audience within the geographic location. Such a process is described with reference to FIG. 4, with continuing reference to FIG. 1 and FIG. 2.

As shown in FIG. 4, the computer-executed process may include acts of receiving an input defining a geographic location, aggregating geographically delineated content for an audience within the geographic location, and aggregating author profile information. Such acts may include those processes executed by components of the service 101 and described herein with reference to acts 204, 206, and 210 of FIG. 2. In further embodiments, the computer-executed process 400 may include the act of enhancing aggregated geographically delineated content as is described herein with reference to at least act 208 of FIG. 2.

At block 402, in various embodiments, influencer information for the audience is determined based on individual influencers for each author within audience. Accordingly, in various implementations, the influencer component may also be configured to determine one or more influencers for the audience based on at least the determined influencer information. Since geographically delineated content may include content from numerous social media platforms, in various embodiments, influencer information may also be associated with numerous social media platforms. Such embodiments are further discussed in detail below with reference to FIGS. 5A-5C.

FIG. 5A shows one example of a process that may be performed by a component of the service 101, such as the influencer component 136 for determining one or more influencers for the audience. At block 502, the service 101 is configured to analyze the aggregated author information and extract author followings. As discussed above, in various embodiments author information may include an author's follow count (e.g., the number of other authors that the author is following), a count of how many other authors are following the author, and the names (e.g., username) of those that the author is following. Such information may be received from multiple social media platforms. The service 101 is configured to identify from the author information each individual, character, group, organization, business, or any other entity that each author of the audience is following. For example, one or more components of the service 101 may be configured to compare following lists for each author within the group. Following lists may be received from one or more social media platforms at which the authors maintain a profile, for example through an API. In one embodiment, information such as the number of followers may be aggregated from multiple social media platforms. Often, determining which individual, character, group, organization, business, or any other entity that each author of the audience is following includes identifying an author profile associated with that entity. In various embodiments, identifying the author profile includes referencing an author profile stored at the database 121. The author profile identified with the desired entity may include a following list, providing an identification of each author that follows the desired entity. In other embodiments, identifying an author profile associated with the particular entity includes identifying an author profile on one or more social media platforms.

At decision block 504, one or more components of the service 101, such as the influencer component 136 are configured to compare those individuals, characters, groups, organizations, businesses, or any other entities, that each author of the audience is following. As mentioned above, this may include comparing one or more following lists. Accordingly, in several embodiments the influencer component is configured to determine one or more author profiles commonly followed by authors within the audience (i.e., shared followings). Shared followings refer to an author profile which at least two other authors within the audience are following. While in some embodiments, those one or more shared followings may be associated with an influencer located within the geographic location, more often than not, the identified influencer will not be located within the geographic location. Various aspects and embodiments appreciate that those individuals, characters, groups, organizations, businesses, or any other entity that influences an audience, need not necessarily be located within that geographic location.

Responsive to comparing, the influencer component 136 is configured to identify each shared following as a potential influencer. It is appreciated that for a large audience (e.g., more than 1,000 authors) there may be a multitude of shared followings. In some embodiments, it may be advantageous to identify each potential influencer as an influencer for the audience. Such may be the case when only a few potential influencers have been identified. However, in other embodiments, such as those in which a large audience is present, the service 101 may perform one or more processes to filter and determine the most relevant potential influencers and influencer information. It is appreciated that certain audiences may be targeted indirectly by identifying and reaching particular influencers.

Accordingly, responsive to the comparing (e.g., as performed by a processor or other component), the influencer component may be configured to aggregate influencer information for each potential influencer. As discussed above, influencer information may include any information descriptive of an influencer, and in particular, a social media influencer. For example, influencer information may include author profile information aggregated from the database 121, or one or more social media providers 120 that corresponds to the potential influencers. In various embodiments, the service 101 may identify duplicate potential influencers so as to prevent provision of duplicate influencer information (e.g., a potential influencer may have more than one author profile, or multiple profiles across various social media platforms). Duplicate profiles may be identified based on social media posts including linked content from one social media provider to another, duplicate author information on or more social media provider platforms, links or handles between profiles on one or more social media provider platforms, or any other appropriate methods.

Responsive to aggregating influencer information for each potential influencer, one or more components of the service 101 are configured to analyze and filter the potential influencers based on at least the aggregated influencer information. For example, at block 508, the influencer component is configured to determine whether a follower count for each potential influencer is above a predetermined threshold. As discussed herein, a follower count may include the amount of authors that follow or subscribe to the potential influencer's social media posts. In further embodiments, the threshold may be dynamically determined by the service 101, and for example, based on the amount of identified potential influencers. In several embodiments, the threshold is set at an amount approximately between a lower limit of 1,000 followers and an upper limit of 1,000,000 followers. While other thresholds could be utilized, such an example targets those potential influencers that are under-utilized. It is appreciated that potential influencers having a follower count between 1,000 and 1,000,000 typically have a dedicated group of followers, without already having been targeted for sponsorships, endorsements, and other targeted advertising. Accordingly, the identified influencers are filtered based on the threshold to determine those influencers most relevant to the audience. Such potential influencers are identified as influencers, and any associated influencer information is provided to the user or client, as described above in act 214 of FIG. 2.

FIG. 5B shows an additional example of a process that may be performed by a component of the service 101, such as the influencer component 136 for determining one or more influencers for the audience. FIG. 5B shares step 502, decision block 504, and step 506 with FIG. 5A, and differs at step 512 and decision block 514.

Responsive to aggregating influencer information for each potential influencer (act 506), one or more components of the service 101 are configured to analyze and filter the potential influencers based on at least the aggregated influencer information. For example, at block 512, the influencer component is configured to compare the amount of authors within an audience whom are following a particular potential influencer and the follower count of that particular influencer. As discussed herein, a follower count may include the amount of authors that follow or subscribe to another's social media posts. While other processes may be employed, in several embodiments, the influencer component is configured to generate a comparison ratio according to:
audience authors following potential influencer/potential influencer's follower count.

For example, an identified geographic location of Boston, Mass., may return 10,000 authors over a span over 24 hours. Of those 10,000 authors, analyzed author information may indicate that 1,000 are following the author Jillian King. Jillian King's following of 100,000 may be compared with the volume of 1,000 to generate the comparison ratio. Such a calculation, performed for example by the influencer component 136, would generate a ratio of 0.01. In various embodiments this ratio may be compared to a predetermined, or automatically generated, threshold to determine those potential influencers most relevant for a given audience. In various other embodiments, a comparison ratio may be generated for each individual potential influencer and individually compared. In aspects and embodiments, the service 101 determines influencers for the audience based on those potential influencers having the highest comparison ratios. It is appreciated that the larger the given ratio, the more relevant the influencer is for the particular audience. For example, Jillian King having a ratio of 0.01 would be a more relevant influencer than Matthew Queen having a ratio of 0.005.

FIG. 5C shows an additional example of a process that may be performed by a component of the service 101, such as the influencer component 136 for determining one or more influencers for the audience. At block 522, the service 101 is configured to analyze the author information and extract author interests. As further discussed herein, author interests may include any specific item in which the author is interested. Interests may include anything that engages, excites, or garners the attention of an author. The service 101 is configured to identify from the author information individual interests for each author within the audience, as discussed above with reference to FIG. 2. Such identification may be performed in real time and may be responsive to new social media postings.

At decision block 524, one or more components of the service 101, such as the influencer component 136 are configured to compare the identified interests of all or a portion of the authors within the audience. Shared interests (i.e., common interests among authors within the audience) may be used to identify one or more influencers for the audience. In several embodiments, the influencer component 136 is configured to determine one or more potential influencers based on the compared interests of the authors within the audience. This may include matching shared interests of the audience with one or more interests assigned to a particular potential influencer. Shared interests may be ranked or assigned a percentage value to indicate those interests most indicative of the interests of the entire audience. While in one embodiment the service 101 may dynamically determine the potential influencers associated with particular interests, in further embodiments the service may provide an interface that permits the user or client to select those interests of the audience most relevant to the geographic location.

In several embodiments, author profiles of one or more potential influencers, whether stored by the service 101 at database 121 or available via one or more content providers 120, may include one or more interests assigned to potential influencers. Interests may be assigned to each influencer based on, for example, relationship, authority, knowledge, status, position, association, or charisma. In one implementation, interests may be assigned to each potential influencer based on the particular followers that the influencer has an influence on. For example, the non-fiction short story novelist Jillian King may have an influence associated with readers of non-fiction short stories and therefore be assigned a “non-fiction short story” interest. Similarly, the Italian restaurant Tony's may have an influence associated with pizza enthusiasts and therefore be assigned a “pizza” interest.

While in one embodiment, interests for a potential influencer may be generated and stored in an associated author profile by one or more components of the service 101 based on the interests of the authors that follow that particular potential influencer, in other embodiments, interests of followers may be identified based on an interest assigned to a potential influencer that they follow. For example, one or more components of service 101 may assign the interest of non-fiction novels to the author profile of a first author responsive to determining that the author follows short story novelist Jillian King. In various further embodiments, interests for an author and/or interests assigned to a potential influencer may be generated, determined, or assigned, based on any appropriate process. While described above in the context of a single author, or a single potential influencer, in various further embodiments, such processes and methods may be performed by the service 101 to generate, determine, or assign one or more interests to an entire audience, groups within an audience, groups of potential influencers, or any other appropriate division of authors and potential influencers.

Responsive to the comparing of block 524, the influencer component 136 is configured to identify potential influencers corresponding to one or more shared interests of the audience (block 526). It is appreciated that for a large audience (e.g., more than 1,000 authors) there may be a multitude of shared interests. In several embodiments, each potential influencer may be identified as an influencer for the audience (e.g., by a computer system). Accordingly, responsive to the comparing, the influencer component may be configured to aggregate influencer information for each potential influencer (block 528). As discussed above, influencer information may include any information descriptive of an influencer, and in particular, a social media influencer. For example, influencer information may include author profile information aggregated from the database 121, or one or more social media providers 120. In further embodiments, one or more components of the service 101 may be configured to further filter the potential influencers and determine one or more influencers for the audience. For example, the influencer component 136 may further filter the potential influencers based on a level of specificity of an assigned interest, or any other appropriate metric, to determine the most relevant influencers. The aggregated influencer information may be provided directly to the user or client, or in some implementations, further analyzed and filtered by the service 101.

Returning briefly to FIG. 4, and in particular to act 404 of FIG. 4, the communication component 116 is configured to provide influencer information to the one or more user devices (e.g., user device 104) or clients (e.g., client 130) permitting the respective user or client to view and interact with the influencer information. In further embodiments, influencer information to social networking sites, social media content providers, or an advertisement system. While in one embodiment the communication component 116 may provide influencer information for those influencers having an influence on authors of the user or client defined geographic location, in further embodiments, the communication component 116 may provide influencer information for any potential influencer identified based on the aggregated author information. In various embodiments, the relation component 114 may generate a visualization from the influencer information. For example, the visualization may include an image of the geographic location. For example, the image may include a street map, a satellite image, a mass transit map, or a geographic depiction.

### Example Computing Device Implementations

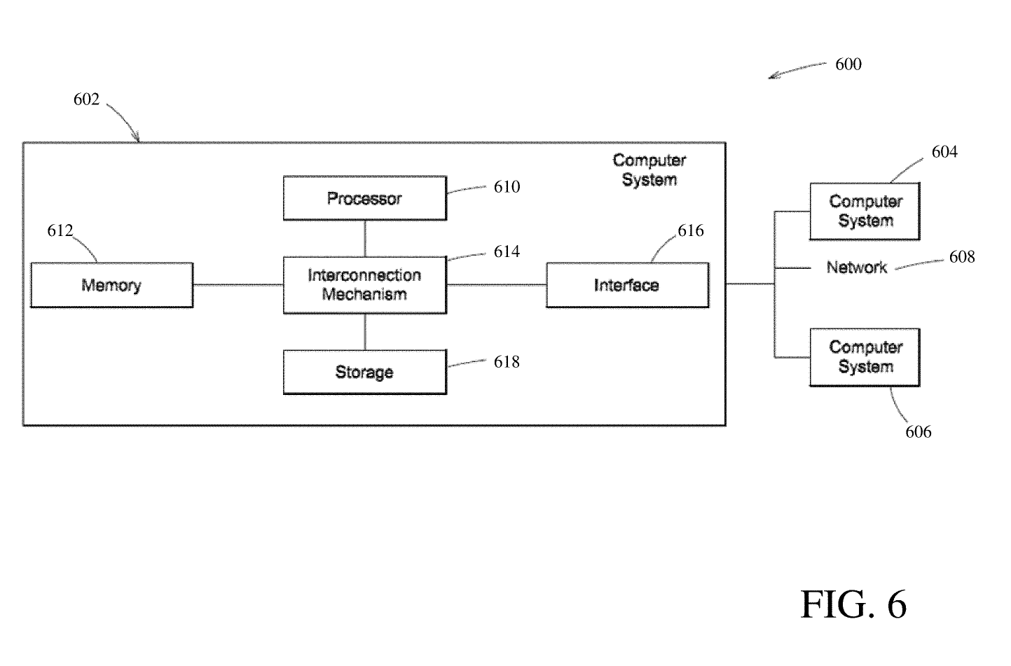

Referring to FIG. 6, there is illustrated a block diagram of a distributed computer system 600, in which various aspects and functions are practiced. As shown, the distributed computer system 600 includes one or more computer systems that exchange information. More specifically, the distributed computer system 600 includes computer systems 602, 604, and 606. As shown, the computer systems 602, 604, and 606 are interconnected by, and may exchange data through, a communication network 608. The network 608 may include any communication network through which computer systems may exchange data. To exchange data using the network 608, the computer systems 602, 604, and 606 and the network 608 may use various methods, protocols and standards to communicate information, including, among others, Fibre Channel, Ethernet, Wireless Ethernet, Bluetooth, IP, IPV6, TCP/IP, UDP, DTN, HTTP, FTP, SMS, MMS, SS7, JSON, SOAP, CORBA, REST, and Web Services. To ensure data transfer is secure, the computer systems 602, 604, and 606 may transmit data via the network 608 using a variety of security measures including, for example, SSL or VPN technologies. While the distributed computer system 600 illustrates three networked computer systems, the distributed computer system 600 is not so limited and may include any number of computer systems and computing devices, networked using any medium and communication protocol.

As illustrated in FIG. 6, the computer system 602 includes a processor 610, a memory 612, an interconnection element 614, an interface 616 and data storage element 618. To implement at least some of the aspects, functions, and processes disclosed herein, the processor 610 performs a series of instructions that result in manipulated data. The processor 610 may be any type of processor, multiprocessor or controller. Example processors may include a commercially available processor such as an Intel Xeon, Itanium, or Core processor; an AMD Opteron processor; an Apple A4 or A5 processor; an IBM Power5+ processor; an IBM mainframe chip; or a quantum computer. The processor 610 is connected to other system components, including one or more memory devices 612, by the interconnection element 614.

The memory 612 stores programs (e.g., sequences of instructions coded to be executable by the processor 610) and data during operation of the computer system 602. Thus, the memory 612 may be a relatively high performance, volatile, random access memory such as a dynamic random access memory (“DRAM”) or static memory (“SRAM”). However, the memory 612 may include any device for storing data, such as a disk drive or other nonvolatile storage device. Various examples may organize the memory 612 into particularized and, in some cases, unique structures to perform the functions disclosed herein. These data structures may be sized and organized to store values for particular data and types of data.

Components of the computer system 602 are coupled by an interconnection element such as the interconnection element 614. The interconnection element 614 may include any communication coupling between system components such as one or more physical busses in conformance with specialized or standard computing bus technologies such as IDE, SCSI, PCI and InfiniBand. The interconnection element 614 enables communications, including instructions and data, to be exchanged between system components of the computer system 602.

The computer system 602 also includes one or more interface devices 616 such as input devices, output devices and combination input/output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system 602 to exchange information and to communicate with external entities, such as users and other systems.

The data storage element 618 includes a computer readable and writeable nonvolatile, or non-transitory, data storage medium in which instructions are stored that define a program or other object that is executed by the processor 610. The data storage element 618 also may include information that is recorded, on or in, the medium, and that is processed by the processor 610 during execution of the program. More specifically, the information may be stored in one or more data structures specifically configured to conserve storage space or increase data exchange performance.

The instructions may be persistently stored as encoded signals, and the instructions may cause the processor 610 to perform any of the functions described herein. The medium may, for example, be optical disk, magnetic disk or flash memory, among others. In operation, the processor 610 or some other controller causes data to be read from the nonvolatile recording medium into another memory, such as the memory 612, that allows for faster access to the information by the processor 610 than does the storage medium included in the data storage element 618. The memory may be located in the data storage element 618 or in the memory 612, however, the processor 610 manipulates the data within the memory, and then copies the data to the storage medium associated with the data storage element 618 after processing is completed. A variety of components may manage data movement between the storage medium and other memory elements and examples are not limited to particular data management components. Further, examples are not limited to a particular memory system or data storage system.

Although the computer system 602 is shown by way of example as one type of computer system upon which various aspects and functions may be practiced, aspects and functions are not limited to being implemented on the computer system 602 as shown in FIG. 6. Various aspects and functions may be practiced on one or more computers having a different architectures or components than that shown in FIG. 6. For instance, the computer system 602 may include specially programmed, special-purpose hardware, such as an application-specific integrated circuit (“ASIC”) tailored to perform a particular operation disclosed herein. In another specially-designed system, both hardware and software may be used to provide a new tool that performs one or more aspects of the present invention. Another example may perform the same operation using a grid of several general-purpose computing devices running MAC OS System X with Intel processors and several specialized computing devices running proprietary hardware and operating systems.

The computer system 602 may be a computer system including an operating system that manages at least a portion of the hardware elements included in the computer system 602. In some examples, a processor or controller, such as the processor 610, executes an operating system. Examples of a particular operating system that may be executed include a Windows-based operating system, such as, Windows Phone, Windows 7, or Windows 8 operating systems, available from the Microsoft Corporation, Android operating system available from Google, Blackberry operating system available from Blackberry Limited, a MAC OS System X operating system or an iOS operating system available from Apple, one of many Linux-based operating system distributions, for example, the Enterprise Linux operating system available from Red Hat Inc., or UNIX operating systems available from various sources. Many other operating systems may be used, and examples are not limited to any particular operating system.

The processor 610 and operating system together define a computer platform for which application programs in high-level programming languages are written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, Ruby, Objective-C, Java, C++, C# (C-Sharp), Python, or JavaScript. Other object-oriented programming languages may also be used. Alternatively, functional, scripting, or logical programming languages may be used.

Additionally, various aspects and functions may be implemented in a non-programmed environment. For example, documents created in HTML, XML or other formats, when viewed in a window of a browser program, can render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Accordingly, the functional components disclosed herein may include a wide variety of elements (e.g., specialized hardware, executable code, data structures or objects) that are configured to perform the functions described herein.

In some examples, the components disclosed herein may read parameters that affect the functions performed by the components. These parameters may be physically stored in any form of suitable memory including volatile memory (such as RAM) or nonvolatile memory (such as a magnetic hard drive). In addition, the parameters may be logically stored in a propriety data structure (such as a database or file defined by a user mode application) or in a commonly shared data structure (such as an application registry that is defined by an operating system). In addition, some examples provide for both system and user interfaces that allow external entities to modify the parameters and thereby configure the behavior of the components.

### Example Interfaces

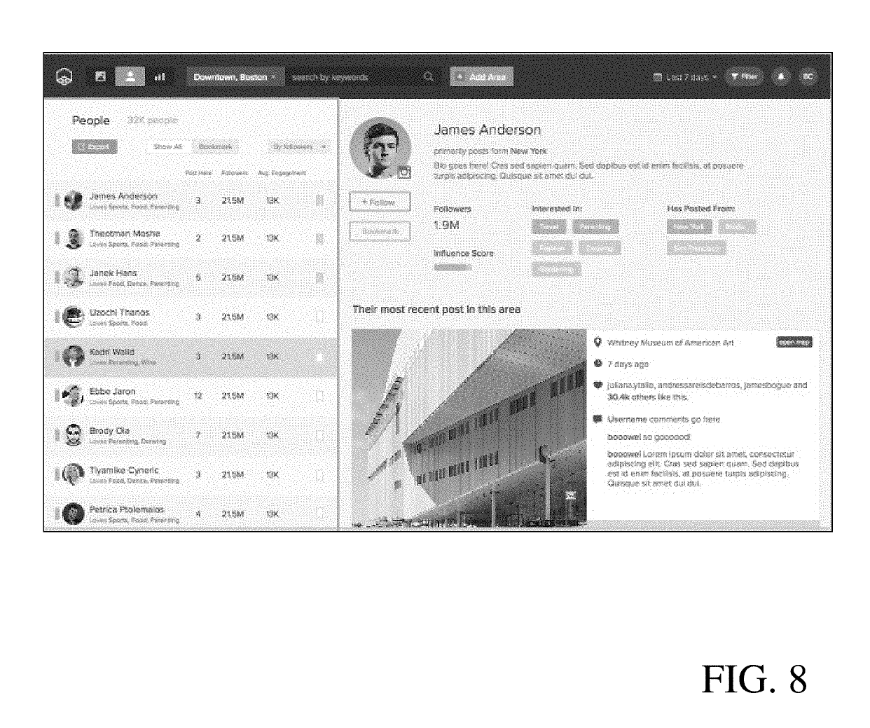

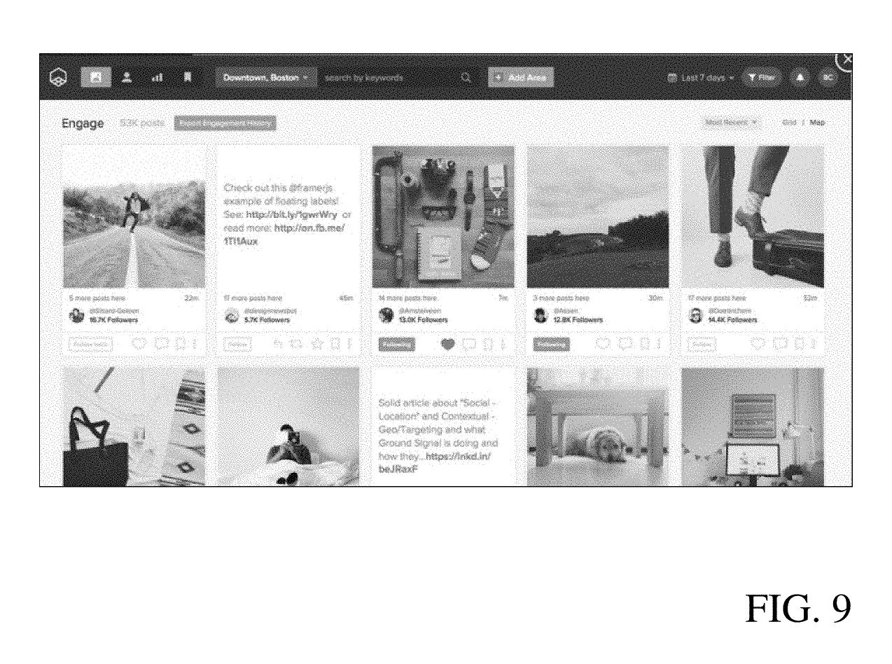

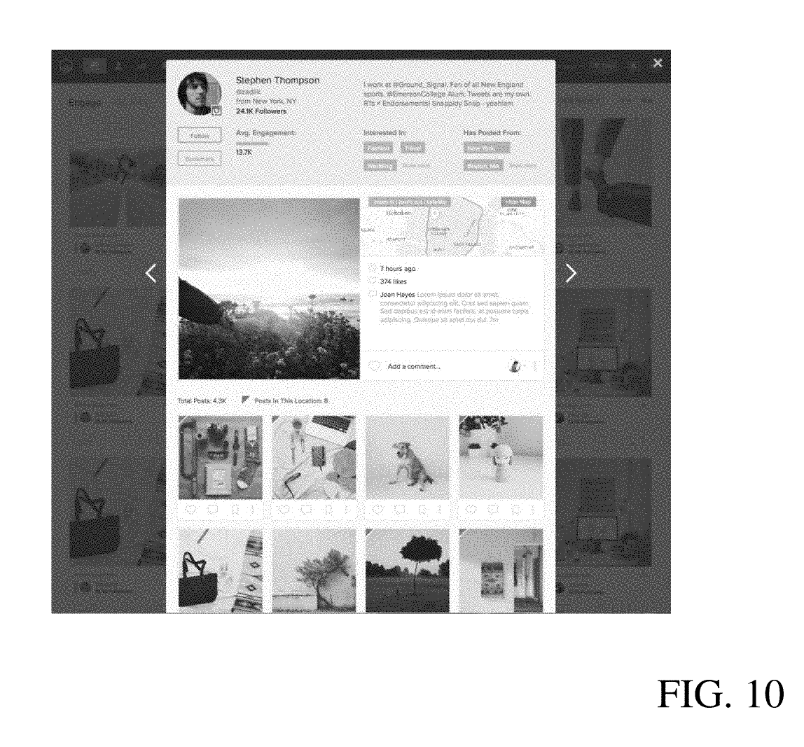

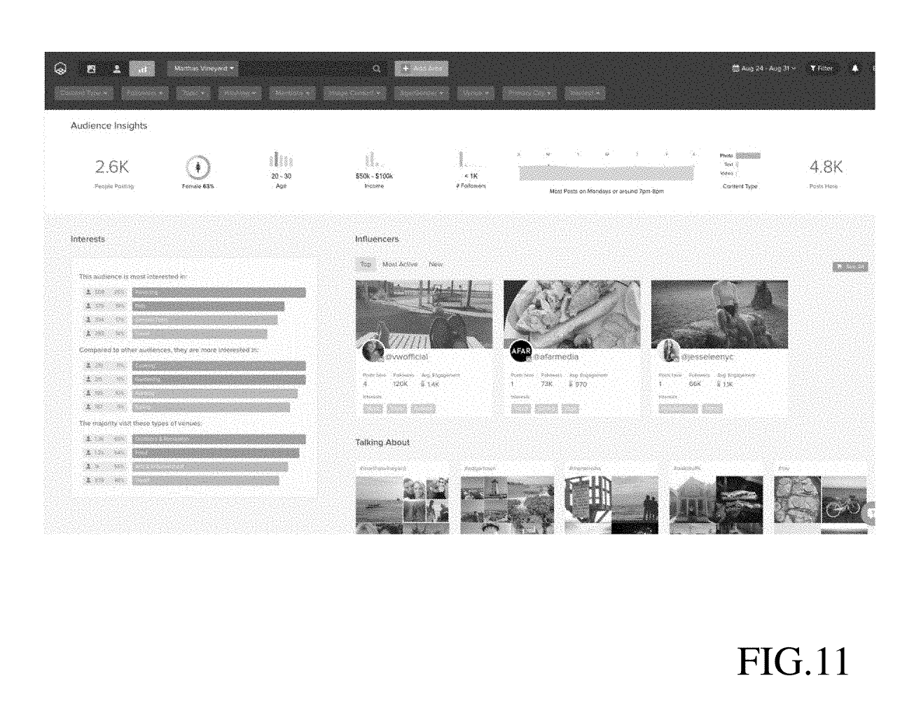

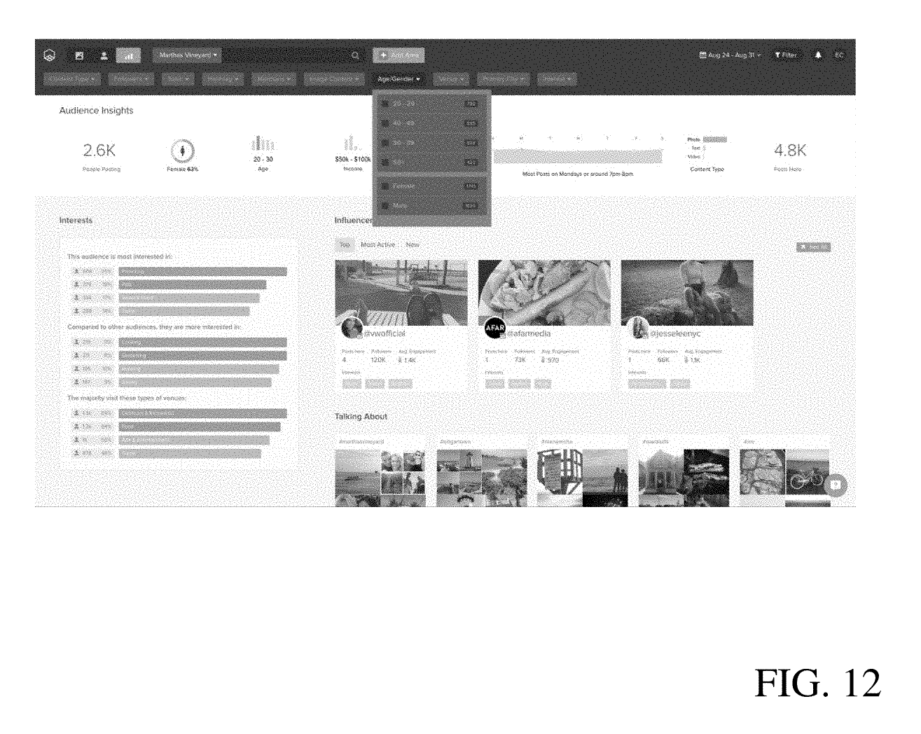

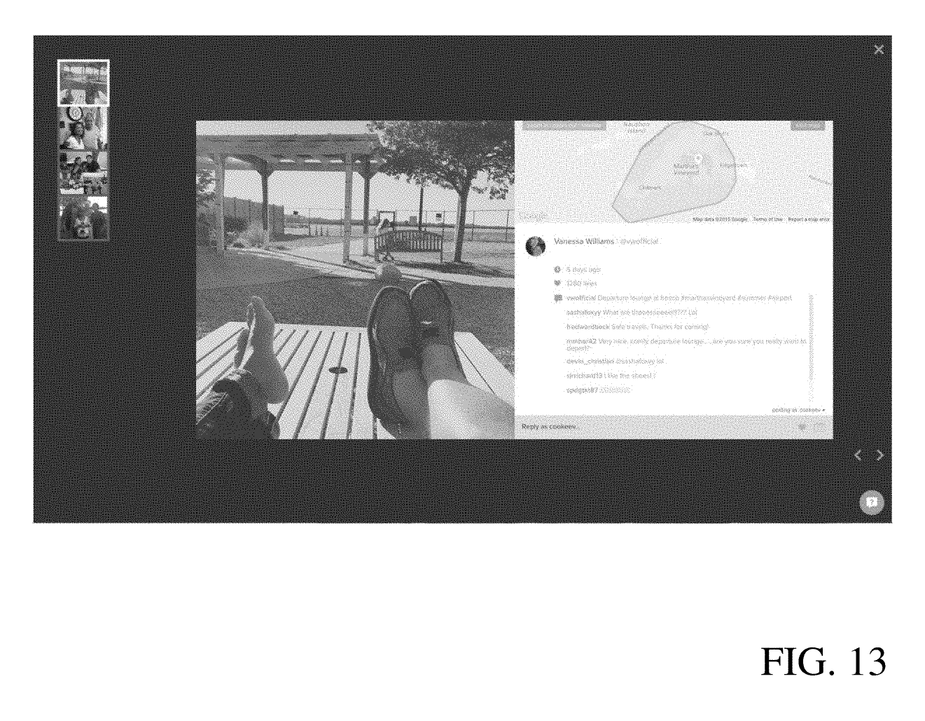

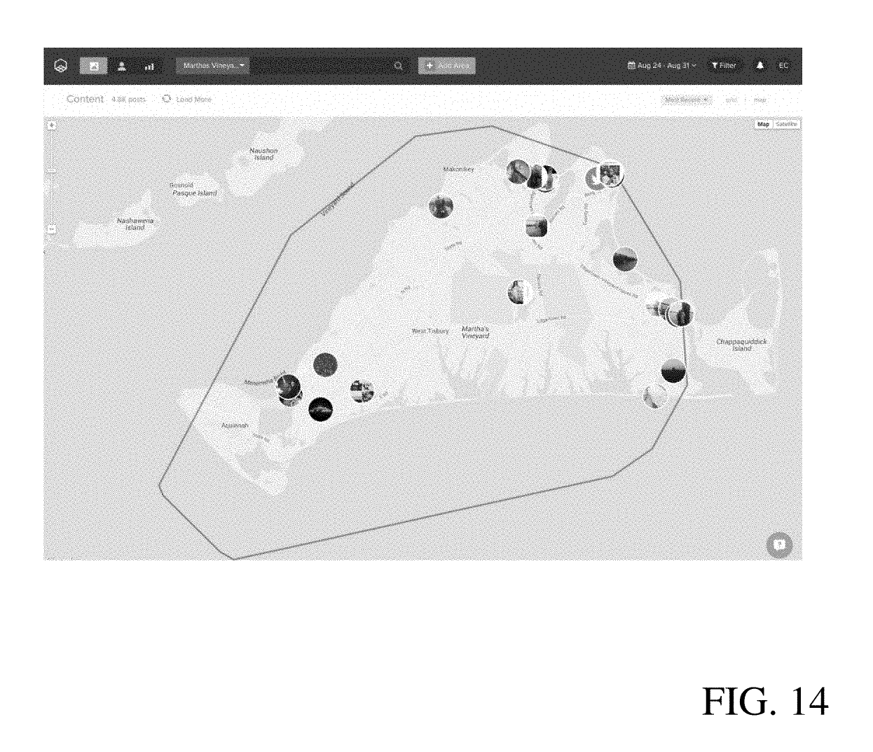

FIGS. 7-14 show examples user interfaces according to various aspects described herein. In particular, FIG. 7 shows a user interface for providing author information corresponding to an author within an identified geographic location. FIG. 8 shows a user interface for providing author information similar to that shown in FIG. 7. FIG. 9 shows a user interface for providing geographically delineated content associated with one or more authors, according to an embodiment. FIG. 10 shows an expansion window corresponding to author information associated with the geographically delineated content provided in the user interface of FIG. 9. FIG. 11 shows a user interface for providing geographically delineated content, author information, influencer information, or metrics, corresponding to an audience within an identified geographic location. FIG. 12 shows a further depiction of the user interface of FIG. 11, in which one or more filters are provided to a user of the user interface. FIG. 13 shows a user interface for providing at least influencer information corresponding to an influencer associated with an identified geographic location. FIG. 14 shows a user interface including an image of an identified geographic location for which various aspects and embodiments may provide author information, influencer information, or geographically delineated content. In various aspects and embodiments, the user interfaces discussed with reference to FIGS. 7-14 may be implemented and controlled through a location-based service, such as the service 101 discussed above with reference to FIG. 1.

FIG. 7 shows one example embodiment of a user interface for providing author information. In various aspects and embodiments, similar user interfaces may be displayed for providing influencer information. As shown in FIG. 7, the interface may provide a display of individual authors within an identified geographic location. For example, individual authors may be arranged in a list or other organized arrangement. Responsive to selection of one or more of the displayed authors, the user interface shows an expanded view of the selected author. FIG. 7 shows an expanded view of the selected author. The user interface may permit the user to filter and control the arrangement of authors, by number of followers, for example, or any other suitable author information.

The user interface may provide more detailed author information for the selected author than that provided in the arranged list of authors. Such author information may include any author information as discussed herein. FIG. 7 shows the provided author information as including at least interests, an influence score, the number of authors following the specified author, location history, a most recently posted social media post and source for the identified geographic location, an image of the geographic location associated with the media post, a post volume, and a post volume for the identified geographic location. Also shown in FIG. 7, the user interface may provide an image or avatar of the author, the author's name, a username of the author, and the author's primary location, among other identifying author information. The user interface may further provide one or more links that connect the user to an author profile on one or more social media provider platforms. The user interface of FIG. 7 may further permit the user to navigate between authors provided in the displayed list of authors. Further, the usr interface may include controls that permit user to rank and/or filter authors based on one or more parameters (e.g., number of followers).

FIG. 8 shows a user interface for providing author information similar to that shown in FIG. 7. As shown in the user interface of FIG. 7, the user interface of FIG. 8 provides a display of individual authors within an identified geographic location. In various embodiments, all authors corresponding to the identified geographic location may be shown in a list or other arrangement. In further embodiments, the user interface permits the user to control the arrangement of displayed authors. Responsive to selection of one or more of the displayed authors, the user interface shows an expanded view of the selected author. In various embodiments, the user interface permits the user to “Bookmark” a selected author. Responsive to activation of a bookmark indicator, various components of the service (e.g., service 101) are configured to save the bookmarked author. The user interface permits the user to control the arrangement of authors by switching between one or more display options, such as all authors, or bookmarked authors. Notably, the card interface may include a consolidated presentation of posting behavior by the author to multiple channels that include parameters such as the number of followers, influence score, and other measured or calculated parameters.

FIG. 9 shows a user interface for providing geographically delineated content generated with one or more authors within an identified geographic location. The shown user interface may display individual media posts as a plurality of cards, each card including author information corresponding to the author that generated the respective media post. While the user interface of FIG. 9 shows an arrangement of cards in rows and columns, any arrangement may be used. Further, arrangements other than cards may be used such as, for example, a grid. As shown, each card may have the content of the media post (e.g., an image or text), author information, and one or more options for the user of the interface to interact with the author of the media post. For example, the user interface shows a first card as including an image, the volume of posts from the author associated with the identified geographic location, an indication of the time the media post was created, an avatar of the author, a username of the author, and the author's follower count. In further embodiments, the user interface of FIG. 9 may further include an indication of whether the user is following the author, a favorite indicator, a message indicator, and one or more card expansion window indicators.

Turning to FIG. 10, shown is an expansion window corresponding to an author associated with the geographically delineated content provided in the user interface of FIG. 9. In various embodiments, the user interface shown in FIG. 9 is configured to display the expansion window of FIG. 10 responsive to selection of a card. As shown, the expansion window provides further detailed author information regarding the author. In addition to the avatar, the username, and the follower count, the expansion window of FIG. 10 provides: a description of the author, interests, historic post locations, an engagement score, a most recent media post, a series of historic media posts, the total volume of media posts, the volume of media posts in the identified geographic location, a comment box, an image of the identified geographic location and the location associated with the media post, the number of likes the most recent post received, comments received on the most recent post, and how long has passed since the most recent post.

FIG. 11 shows an example user interface in which one or more aspects and embodiments may provide influencer information, interest data, and various metrics corresponding to an audience of authors within an identified geographic location. FIG. 11 shows an example user interface for the identified geographic location of Martha's Vineyard, Mass. In at least one embodiment, the user interface provides the volume of authors generating geographically delineated content (e.g., social media posts), an indicator of the gender distribution (e.g., 63% female), an indicator of the average age of the authors (e.g., 20-30 years old), the average income of the authors (e.g., $50k-$100k), and the average number of followers following each author (e.g., less than 1,000 followers). The user interface may also provide an indicator of post volume over a predetermined time frame. The user interface may also provide information regarding the type of content being generated by the audience of authors. For example, FIG. 11 shows the interface as providing an indicator showing that the majority of geographically delineated content includes photos, and the total post volume is about 4,800 posts.

With continuing reference to the user interface shown in FIG. 11, in various embodiments one or more user interfaces may provide influencer information for the audience of authors within the identified geographic location. For example, FIG. 11 shows the user interface including influencer information for authors associated with the Martha's Vineyard, Mass. location. In at least one implementation, activation of one or more tabs may transition the display of influencer information. For example, tabs may correspond to various arrangements of influencers and influencer information for a given location. FIG. 11 shows the user interface as displaying a “Top”, “Most Active”, and a “New” influencer tab. Activation (e.g., selection by the user) of one or more tabs rearranges the display of influencers and influencer information. While any influencer information may be provided within the influencer tabs, FIG. 11 shows the “Top” tab as including a username, an avatar, a volume of posts associated with the identified geographic location, an engagement score, and interests associated with each influencer.

In various embodiments, one or more user interface, such as that discussed with reference to FIG. 11, may provide interest data associated with the audience. Interest data may include the interests of each author of the audience, as discussed above. As shown, interests may be displayed in an arrangement such that various interests amongst the audience may be compared. While shown in FIG. 11 as bar graphs, any graphical comparison or arrangement may be displayed. FIG. 11 shows the top interests (e.g., parenting, pets, general food, and travel) within the authors of the audience displayed with a corresponding volume of authors and percentage. FIG. 11 also shows the user interface as providing a comparison of interests of the audience to a base of interests for the rest of the world. In particular, compared to other audiences, authors within the identified geographic location of Martha's Vineyard are more interested in cooking, gardening, running, and sailing. Each interest is provided with a corresponding volume of authors and percentage. Lastly, the user interface shown in FIG. 11 may include venue interests of the authors within the audience. FIG. 11 shows the user interface providing that authors within the identified geographic location of Martha's Vineyard have venue interests including Outdoors & Recreation, Food, Arts & Entertainment, and Travel. Each venue interest is displayed with a corresponding volume of authors and a percentage. Notably, the interface shows a representation of author influencers for the identified audience, and these influencers may be targeted to indirectly reach the indicated audience.

In various embodiments, the user interface shown in FIG. 11 may also provide a list of trending topics, or other metrics associated with geographically delineated content generated by authors within the audience. For example, the user interface shown in FIG. 8 provides an arrangement of trending hashtags (e.g., #marthasvineyard, #edgartown, #menemsha, #oakbluffs, and #mv) and associated images or descriptions. Also shown in FIG. 11, the user interface may further provide on or more filters that filter geographically delineated, author information, or influencer information responsive to one or more selections. For example, FIG. 11 shows one embodiment of the user interface as providing a Content Type filter, a Followers filter, a Topic filter, a Mentions filter, an Image Content filter, an Age/Gender filter, a Venue filter, a Primary City filter, and an Interest filter. Provided filters are further shown and described with reference to FIG. 12.

FIG. 12 shows a further example of the interface of FIG. 11, in which one or more filters are provided to a user of the interface. In various embodiments, the user interface is configured to display one or more expansion windows responsive to selection of a filter. For example, FIG. 12 shows the user interface providing an Age/Gender expansion window. Each expansion window may include at least one option for further filtering the displayed geographically delineated content, author information, influencer information, or metrics. For example, the shown expansion window for the Age/Gender filter includes options 20-29, 40-49, 30-39, and 50+. It is appreciated that various options may be used, and the shown options are provided as a means of example. Each option may be further ranked according to a volume of influencers, or authors, associated with that option. For example, the various options shown in the Age/Gender expansion window are ranked according to a volume of authors within the audience (e.g., 20-29 includes 786 authors, 40-49 includes 595 authors, 30-39 includes 528 authors, and 50+ includes 423 authors. The expansion window is also shown as including options for male and female.

In various embodiments, responsive to selection of one or more options, the user interface may refresh, or re-provide displayed geographically delineated content, author information, influencer information, or metrics, corresponding to the selected options. For example, responsive to selection of the 20-29 age option, the user interface may filter and display only geographically delineated content, author information, influencer information, and metrics associated with geographically delineated content generated by an author having an associated age within the age group 20-29. Various embodiments for identifying, aggregating, and enriching this displayed content and information are discussed above.

Turning to FIG. 13, one example of an interface for providing at least influencer information corresponding to an influencer associated with an identified geographic location is shown. FIG. 13 is described with continuing reference to the example user interface discussed above with reference to FIGS. 11 and 12. In various embodiments, one or more user interfaces are configured to display an influencer page responsive to selection of a particular influencer within an influencer tab of a user interface (e.g., the influencer tab discussed with reference to FIGS. 11 and 12 above). FIG. 13 shows one such example of an influencer page. In various embodiments, the influencer page may provide the influencer's name, username, avatar, and activity. The influencer page may also provide a geographic location associated with the influencer's most recent media post, the number of likes that post received, comments or feedback on that post, and one or more links to contact that influencer (e.g., “reply as”). In further embodiments, the user interface may further provide content including other media posts from the influencer that have a similar, or same, geographic location associated therewith. Responsive to selection of one or more of the posts having a similar, or the same, geographic location, the user interface is configured to provide an updated window corresponding to that post. In various embodiments, the interface provides one or more navigation tools permitting a user to navigate between various influencer windows corresponding to influencers for the audience.

FIG. 14 shows an example user interface including an image of an identified geographic location for which various aspects and embodiments may provide author information, influencer information, or geographically delineated content. As shown in FIG. 14, in various embodiments one or more user interfaces may include an image (e.g., map) of the identified geographic location. For example, the user interface of FIG. 14 is shown as providing an image of the identified geographic location of Martha's Vineyard. While shown as a map, the image may include a street map, a satellite image, a mass transit map, or any other geographic depiction. The user interface provides one or more indicators layered over the displayed image. While in various embodiments the indicators may correspond to a heatmap, in at least one implementation the indicators may indicate the location of an author or an influencer. Each indicator may be personalized to the particular author or influencer. For example, in FIG. 14 each indicator corresponds to an avatar of an associated influencer. In further embodiments, each indicator may correspond to a media post, a group of media posts, a group of authors, a group of influencers, or any combination of the foregoing. Responsive to selection of one or more indicators, the user interface is configured to display author information, influencer information, or geographically delineated content associated with that indicator. In further embodiments, the interface may further provide one or more view indicators permitting the user to zoom-in or zoom-out on the image of the identified geographic location.

Accordingly, embodiments disclosed herein include services, application systems, applications, and methods for geographically delineated content provision. Geographically delineated content can include social media content that is relevant to one or more geographic locations, and information associated with the author whom generated the content. For example content can include text, photographs, videos, and/or audio files. Although social media content providers as described herein include social media platforms such as Twitter, Facebook, MySpace, LinkedIn, Pinterest and Tumblr, in further embodiments, providers can include any social media content provider as is understood in the art.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only.

What is claimed is:

1. A computer system comprising:
an interface configured to receive an input defining a geographic location;
a location-based service including a distributed computer system having at least one processor in data communication with the interface;
a delineation component adapted to aggregate geographically delineated content for an audience within the geographic location, the aggregated geographically delineated content including a plurality of social media posts each generated by an author within the geographic location;
an enrichment component adapted to aggregate author profile information associated with each social media post of the plurality of social media posts;
an influencer component adapted to determine influencer information for the audience based at least in part on the author profile information; and
a communication component adapted to provide the influencer information.

2. The computer system of claim 1, wherein author information includes at least following data and the influencer component is further adapted to determine at least one influencer for the audience.

3. The computer system of claim 2, wherein the influencer component is further adapted to determine the at least one influencer for the audience based on shared followings between a first author profile and a second author profile.

4. The computer system of claim 2, wherein the influencer component is further adapted to determine the at least one influencer for the audience based on a follower count, wherein the follower count is substantially between 1,000 and 1,000,000 followers.

5. The computer system of claim 4, wherein the influencer component is further adapted to determine the at least one influencer for the audience based on a comparison of the following information and the follower count.

6. The computer system of claim 5, wherein the comparison of following information and follower count is a ratio of following information to follower count.

7. The computer system of claim 2, further comprising a relation component adapted to generate an advertisement targeted to the at least one influencer for the audience.

8. The computer system of claim 2, wherein the influencer component is further adapted to assign an interest to the at least one influencer for the audience.

9. The computer system of claim 1, wherein author information includes at least engagement information and the influencer component is further adapted to determine at least one influencer for the audience based on the engagement information.

10. The computer system of claim 1, wherein the system is adapted to receive and store the geographically delineated content at a database, the database indexed based on a geographical mapping.

11. A computer-executed method comprising:
receiving an input defining a geographic location;
aggregating geographically delineated content for an audience within the geographic location, the aggregated geographically delineated content including a plurality of social media posts each generated by an author within the geographic location;
aggregating author profile information associated with each social media post of the plurality of social media posts;
determining influencer information for the audience based at least in part on the author profile information; and
providing the influencer information.

12. The computer-executed method of claim 11, wherein author information includes at least following data, and the method further comprises determining at least one influencer for the audience.

13. The computer-executed method of claim 12, wherein determining at least one influencer for the audience includes determining the at least one influencer for the audience based on shared followings between a first author profile and a second author profile.

14. The computer-executed method of claim 12, wherein determining at least one influencer for the audience includes determining the at least one influencer for the audience based on a follower count, wherein the follower count is substantially between 1,000 and 1,000,000 followers.

15. The computer-executed method of claim 14, further comprising determining the at least one influencer for the audience based on a comparison of the following information and the follower count.

16. The computer-executed method of claim 15, wherein the comparison of following information and follower count is a ratio of following information to follower count.

17. The computer-executed method of claim 12, further comprising generating an advertisement targeted to the at least one influencer for the audience.

18. The computer-executed method of claim 12, further comprising assigning an interest to the at least one influencer for the audience.

19. The computer-executed method of claim 11, wherein author information includes at least engagement information, and the method further includes determining the at least one influencer for the audience based on the engagement information.

20. The computer-executed method of claim 11, further comprising receiving and storing the geographically delineated content at a database, the database indexed based on a geographical mapping.

21. A computer system comprising:
an interface configured to receive an input defining a geographic location;
a location-based service including a distributed computer system having at least one processor in data communication with the interface;
an enrichment component adapted to aggregate author information for an audience within the geographic location, the author information associated with geographically delineated content including a plurality of social media posts, each post being generated by an author within the geographic location; and
a communication component adapted to provide the author information.

22. The system of claim 21, wherein author information includes author profile information associated with each social media post of the plurality of social media posts.

23. The system of claim 21, further comprising a trend component adapted to detect an incongruity from a comparison of the author information for the audience within the geographic location and an audience not within the geographic location.

24. The system of claim 23, wherein the trend component is adapted to detect the incongruity by comparing interest data for the audience within the geographic location and interest data for the audience not within the geographic location.

25. The system of claim 23, wherein the trend component is further adapted to filter the author information at least in part based on interest data for the audience within the geographic location.

26. The system of claim 25, wherein the trend component is adapted to filter the author information by parsing the interest data based on a level of descriptiveness.

27. The system of claim 21, further comprising a relation adapted to generate an advertisement for the audience.

28. The system of claim 21, further comprising a relation component adapted to generate an advertisement for an author having an associated geographic location within the geographic location.

29. The system of claim 21, wherein the author information includes a travel history of each author within the audience, the travel history being based at least in part on a geographic location associated with a previous social media post.

30. The system of claim 21, wherein the enrichment component is further adapted to determine a connection between at least a first author of the audience and a second author of the audience, and wherein the author information includes the determined connection.

31. The system of claim 21, further comprising a delineation component adapted to aggregate the geographically delineated responsive to receiving the input defining the geographic location.

32. The system of claim 31, wherein the input further includes at least one query parameter defining author characteristics.

33. The computer system of claim 31, wherein the system is adapted to receive and store the geographically delineated content at a database, the database indexed based on a geographical mapping.

34. A computer-executed method comprising:
receiving an input defining a geographic location;
aggregating author information for an audience within the geographic location, the author information associated with geographically delineated content including a plurality of social media posts, each post being generated by an author within the geographic location; and
providing the author information.

35. The computer-executed method of claim 34, wherein author information includes author profile information associated with each social media post of the plurality of social media posts.

36. The computer-executed method of claim 34, detecting an incongruity from a comparison of the author information for the audience within the geographic location and an audience not within the geographic location.

37. The computer-executed method of claim 36, wherein detecting the incongruity includes comparing interest data for the audience within the geographic location and interest data for the audience not within the geographic location.

38. The computer-executed method of claim 36, further comprising filtering the author information at least in part based on interest data for the audience within the geographic location.

39. The computer-executed method of claim 38, wherein filtering the author information includes parsing the interest data based on a level of descriptiveness.

40. The computer-executed method of claim 34, further comprising generating an advertisement for the audience.

41. The computer-executed method of claim 34, further comprising generating an advertisement for an author having an associated geographic location within the geographic location.

42. The computer-executed method of claim 34, wherein the author information includes a travel history of each author within the audience, the travel history being based at least in part on a geographic location associated with a previous social media post.

43. The computer-executed method of claim 34, further comprising determining a connection between at least a first author of the audience and a second author of the audience, and wherein the author information includes the determined connection.

44. The computer-executed method of claim 34, further aggregating the geographically delineated responsive to receiving the input defining the geographic location.

45. The computer-executed method of claim 44, wherein the input further includes at least one query parameter defining author characteristics.

46. The computer-executed method of claim 44, further comprising receiving and storing the geographically delineated content at a database, the database indexed based on a geographical mapping.
